(19) United States
(12) Patent Application Publication
(10) Pub. No.: US 2015/0269344 A1
(43) Pub. Date: Sep. 24, 2015

(54) SYSTEM AND METHOD FOR COORDINATING HEALTH CARE PLANS

(71) Applicant: Mark Repko, Indianapolis, IN (US)

(72) Inventor: Mark Repko, Indianapolis, IN (US)

(73) Assignee: MedDiary, Inc., Indianapolis, IN (US)

(21) Appl. No.: 14/661,564

(22) Filed: Mar. 18, 2015

Related U.S. Application Data
(60) Provisional application No. 61/955,081, filed on Mar. 18, 2014.

(51) Int. Cl. G06F 19/00

(52) U.S. Cl. CPC G06F 19/3425; G06F 19/322

(57) ABSTRACT

A computerized method and system for coordinated healthcare management is disclosed. The method includes receiving a first health care plan for a patient from a first provider, receiving a second health care plan for the patient from a second provider, coordinating the first health care plan with the second health care plan to generate a coordinated health care plan, the coordinated health care plan comprising one or more health events associated with the patient, receiving at least one threshold for at least one of the one or more health events from the first provider, and alerting the first provider upon receiving an indication that the one of the one or more health events is outside the threshold.

### CROSS REFERENCE TO RELATED APPLICATION

The present application claims the benefit of commonly owned U.S. Provisional Patent Application Ser. No. 61/955,081 filed on Mar. 18, 2014 which is hereby incorporated by reference in its entirety.

### BACKGROUND

Lifelong or chronic illnesses create a special managed care relationship between a patient and one or more providers. Health practitioners provide guidance to patients on how to maintain an appropriate lifestyle concerning food choices, exercise, and other attributes and/or monitor various symptoms, measured health values, or other information about the patient. For example, a doctor working with a patient diagnosed with diabetes may identify an appropriate daily caloric and carbohydrate intake for the patient. After leaving the doctor's office, the patient is tasked with monitoring his or her own consumption in accordance with the doctor's recommendations.

To avoid emergency situations and to help a patient comply with a provider's recommendations, a patient may use an electronic device to track and upload measured health attributes to a provider. In addition, the patient may provide feedback regarding certain trigger symptoms that a provider may be interested in knowing about. For example, a doctor may be interested in learning that a diabetes patient is suffering from swelling in his or her legs, and the patient may use an electronic device to indicate such symptoms to the doctor.

In response to the information provided by the patient through such an electronic device, a provider may react by proscribing medication, setting up appointments for follow up with the patient, or even recommending that the patient check himself or herself into an emergency room.

Today, this provider to patient relationship works when a patient suffers only from one lifelong or chronic illness. If a patient suffers from multiple illnesses (i.e. diabetes and Crohn's disease), the patient may be required to report information in multiple formats to multiple providers in multiple systems. Moreover, such providers may not know what medication is proscribed or other recommendations made by other providers managing different chronic illnesses. For example, a provider assisting a patient for diabetes may not know what the patient is being proscribed for Crohn's disease from another doctor. In this same example, the patient may be required to report similar measured health care values (i.e. caloric intake) to each provider individually for evaluation.

Accordingly, there exists a need for a method and system for coordinating health care plans.

### BRIEF DESCRIPTION OF THE DRAWINGS

FIG. 1 illustrates a flowchart of a method for coordinating health care plans according to at least one embodiment of the present disclosure.

FIG. 2 displays the architecture of a system for coordinating health care plans according to at least one embodiment of the present disclosure.

FIG. 3 displays a screenshot of a user interface presented in association with a system and/or method for coordinating health care plans according to at least one embodiment of the present disclosure.

FIG. 4 displays a screenshot of a user interface presented in association with a system and/or method for coordinating health care plans according to at least one embodiment of the present disclosure.

FIG. 5 displays a screenshot of a user interface presented in association with a system and/or method for coordinating health care plans according to at least one embodiment of the present disclosure.

FIG. 6 displays a screenshot of a user interface presented in association with a system and/or method for coordinating health care plans according to at least one embodiment of the present disclosure.

FIG. 7 displays a screenshot of a user interface presented in association with a system and/or method for coordinating health care plans according to at least one embodiment of the present disclosure.

FIG. 8 displays a screenshot of a user interface presented in association with a system and/or method for coordinating health care plans according to at least one embodiment of the present disclosure.

FIG. 9 displays a screenshot of a user interface presented in association with a system and/or method for coordinating health care plans according to at least one embodiment of the present disclosure.

FIG. 10 displays a screenshot of a user interface presented in association with a system and/or method for coordinating health care plans according to at least one embodiment of the present disclosure.

FIG. 11 displays a screenshot of a user interface presented in association with a system and/or method for coordinating health care plans according to at least one embodiment of the present disclosure.

FIG. 12 displays a screenshot of a user interface presented in association with a system and/or method for coordinating health care plans according to at least one embodiment of the present disclosure.

FIG. 13 displays a screenshot of a user interface presented in association with a system and/or method for coordinating health care plans according to at least one embodiment of the present disclosure.

FIG. 14 displays a screenshot of a user interface presented in association with a system and/or method for coordinating health care plans according to at least one embodiment of the present disclosure.

FIG. 15 displays a screenshot of a user interface presented in association with a system and/or method for coordinating health care plans according to at least one embodiment of the present disclosure.

FIG. 16 displays a screenshot of a user interface presented in association with a system and/or method for coordinating health care plans according to at least one embodiment of the present disclosure.

FIG. 17 displays a screenshot of a user interface presented in association with a system and/or method for coordinating health care plans according to at least one embodiment of the present disclosure.

FIG. 18 displays a screenshot of a user interface presented in association with a system and/or method for coordinating health care plans according to at least one embodiment of the present disclosure.

FIG. 19 displays a screenshot of a user interface presented in association with a system and/or method for coordinating health care plans according to at least one embodiment of the present disclosure.

FIG. 20 displays a screenshot of a user interface presented in association with a system and/or method for coordinating health care plans according to at least one embodiment of the present disclosure.

FIG. 21 displays a screenshot of a user interface presented in association with a system and/or method for coordinating health care plans according to at least one embodiment of the present disclosure.

FIG. 22 displays a screenshot of a user interface presented in association with a system and/or method for coordinating health care plans according to at least one embodiment of the present disclosure.

FIG. 23 displays a screenshot of a user interface presented in association with a system and/or method for coordinating health care plans according to at least one embodiment of the present disclosure.

FIG. 24 displays a screenshot of a user interface presented in association with a system and/or method for coordinating health care plans according to at least one embodiment of the present disclosure.

FIG. 25 displays a screenshot of a user interface presented in association with a system and/or method for coordinating health care plans according to at least one embodiment of the present disclosure.

FIG. 26 displays a screenshot of a user interface presented in association with a system and/or method for coordinating health care plans according to at least one embodiment of the present disclosure.

FIG. 27 displays a screenshot of a user interface presented in association with a system and/or method for coordinating health care plans according to at least one embodiment of the present disclosure.

FIG. 28 displays a screenshot of a user interface presented in association with a system and/or method for coordinating health care plans according to at least one embodiment of the present disclosure.

FIG. 29 displays a screenshot of a user interface presented in association with a system and/or method for coordinating health care plans according to at least one embodiment of the present disclosure.

FIG. 30 displays a screenshot of a user interface presented in association with a system and/or method for coordinating health care plans according to at least one embodiment of the present disclosure.

FIG. 31 displays a screenshot of a user interface presented in association with a system and/or method for coordinating health care plans according to at least one embodiment of the present disclosure.

FIG. 32 displays a screenshot of a user interface presented in association with a system and/or method for coordinating health care plans according to at least one embodiment of the present disclosure.

### DETAILED DESCRIPTION

For the purposes of promoting an understanding of the principles of the present disclosure, reference will now be made to the embodiments illustrated in the drawings, and specific language will be used to describe the same. It will nevertheless be understood that no limitation of the scope of this disclosure is thereby intended.

This detailed description is presented in terms of programs, data structures or procedures executed on a computer or network of computers. The software programs implemented by the system may be written in languages such as Ruby, PHP, Perl, ASP.net, Java, HTML, HTML5, Python, C, C++, C#, Javascript, and/or the Go programming language. It should be appreciated, of course, that one of skill in the art will appreciate that other language may be used instead, or in combination with the foregoing and that web and/or mobile application frameworks may also be used, such as, for example, Ruby on Rails, Jo, Twitter bootstrap, and others. It should further be appreciated that the systems and methods disclosed herein may be embodied in software-as-a-service, mobile applications, or other types of software made available over a computer network, such as, for example, the Internet.

It should be appreciated that the methods and systems disclosed herein may be used in connection with the systems and methods disclosed in International Publication Number WO2013019209 A1, PCT/US2011/046162, filed on Aug. 1, 2011, incorporated by reference in its entirety herein.

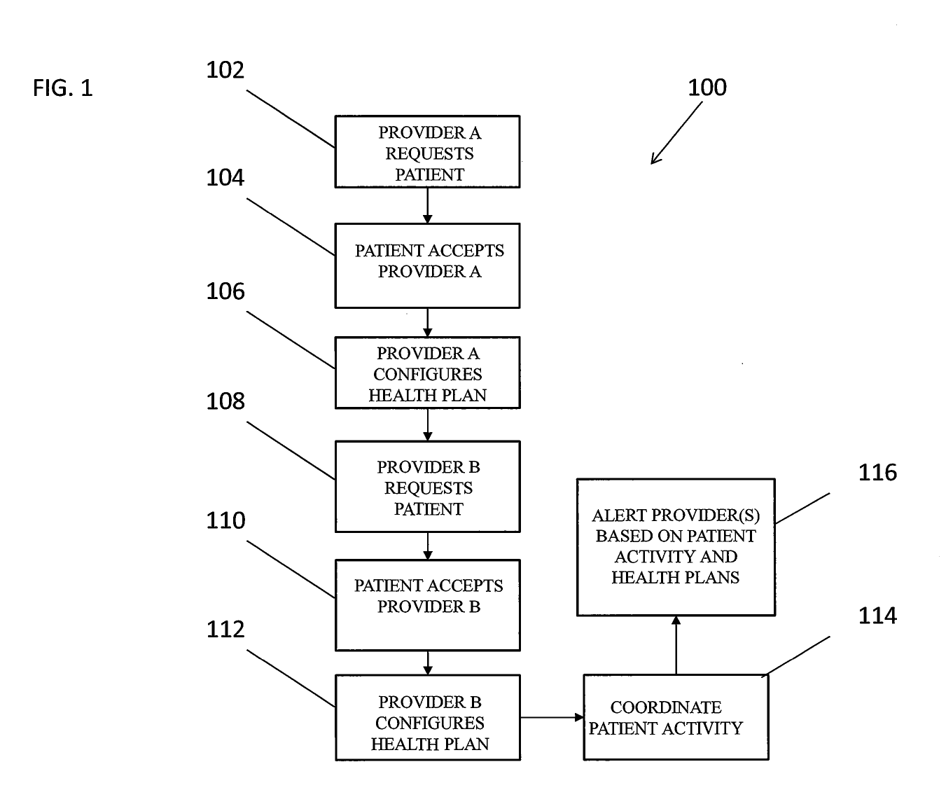

Referring now to FIG. 1, it is shown a method 100 for coordinating health care plans according to at least one embodiment of the present disclosure. As shown in FIG. 1, the method 100 includes a provider requesting access to a patient in step 102, a patient accepting the provider in step 104, the provider configuring a health plan in step 106, a second provider requesting access to the patient in step 108, the patient accepting the second provider in step 110, the second provider configuring a health plan in step 112, coordinating patient activity in step 114, and alerting one or both of the providers based on patient activity and the configured health plans. It should be appreciated that the steps of the method 100 may be executed in any order and/or that not all steps are required to be performed.

A patient with one or more chronic or lifelong illnesses may work with one or more healthcare practitioners to manage measured health values, address symptoms, and generally monitor patient activity in an effort to manage such illnesses. In at least one embodiment of the present disclosure, this management may be performed electronically with a patient tracking his or her behavior, measured health attributes, and other information through an electronic device according to a healthcare provider's specialized health care plan for the patient's chronic or lifelong illness. In such an embodiment, the patient may input measured health care values, symptoms, and other information through an electronic device, like a smartphone, tablet, laptop, desktop, personal computer, wearable device, or other network-capable device to a system over a computer network, like the Internet.

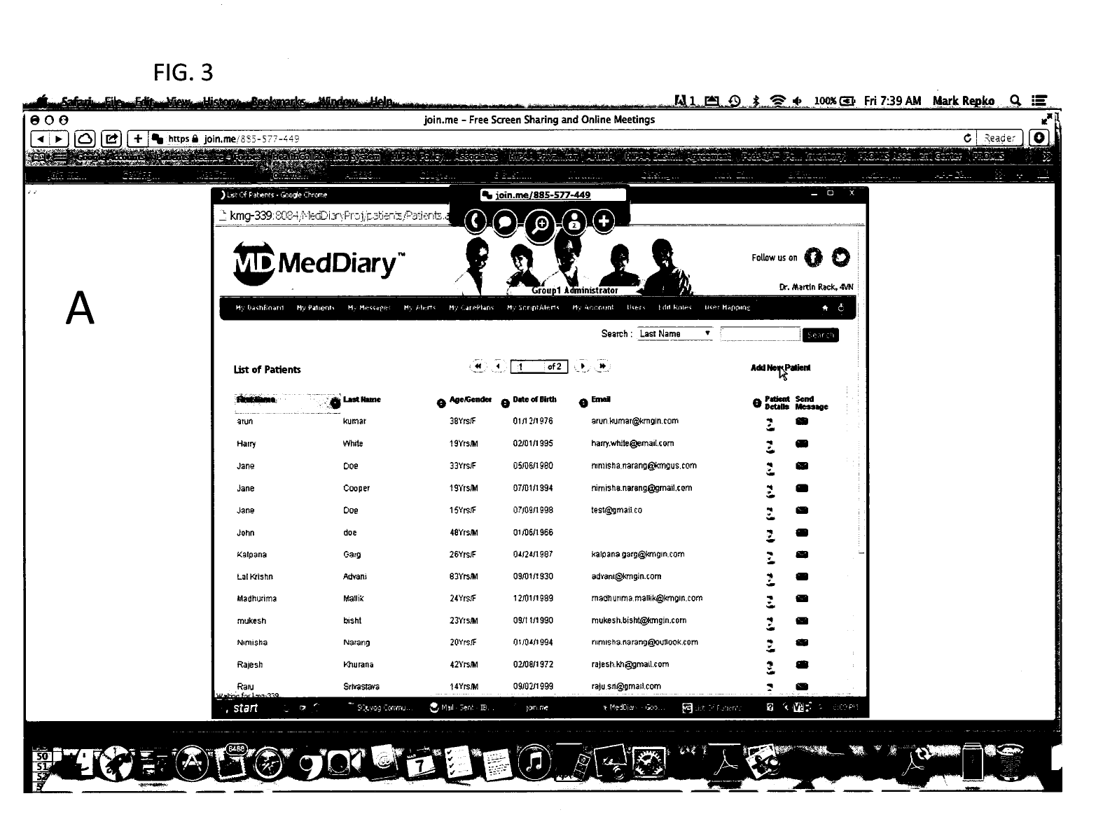

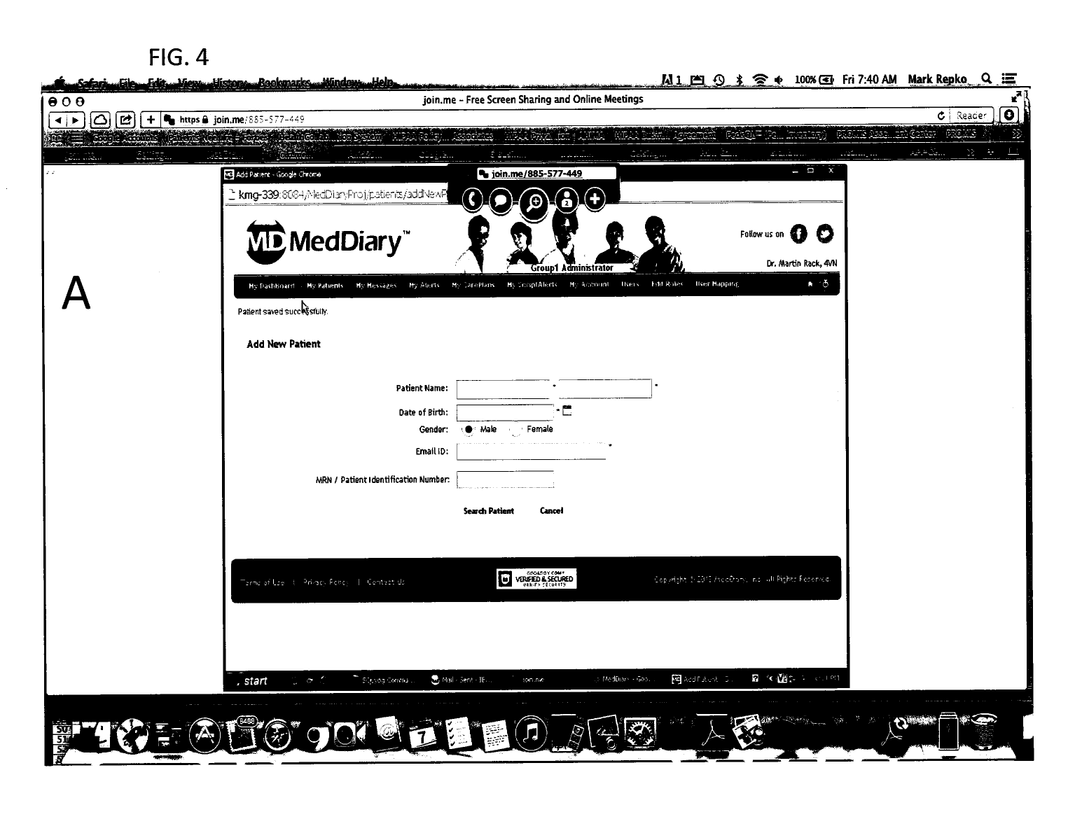

A healthcare provider desirous of providing care to a patient may request access to a patient's profile in step 101. In such an embodiment, the provider may have a list of patients, such as those shown in example FIG. 3 in which the provider is already providing various types of care. In this example, provider A intends to add a patient and may search a system in the step 100 for the patient by name, date of birth, gender, email address, a unique identifier for the patient, or any other contact information stored within the system. The provider may search for the patient in a text-based form, mobile application, or other interface, such as the one shown in FIG. 4. Upon searching for the patient by name, the provider may obtain a list of patients through the system and request access to the patient of interest. There, the provider may select a patient searched within the system and request access to the patient.

It should be appreciated that in an exemplary embodiment the system may be configured to require providers to search for patients by a set of required attributes to preserve patient confidentiality. The system may require, for example, that a provider know a patient's full first name and last name to search him or her within the system. In another example, the system may require that the provider input the patient's unique identifier within the system to find the patient.

In at least one embodiment of the present disclosure, a provider requesting access to the patient in step 100 may send a communication to the patient to authorize such access. The communication may be a push notification to a mobile device through a mobile application, an SMS, email, phone call, MMS, or other electronic communication able to be received on an electronic device.

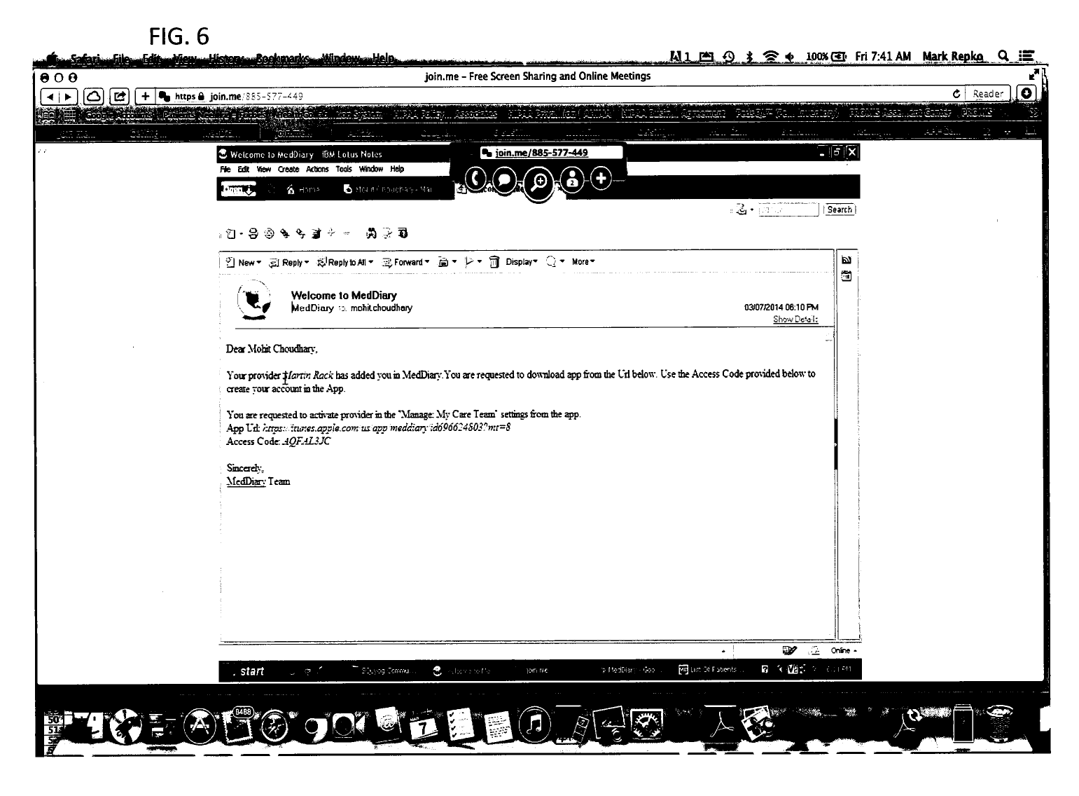

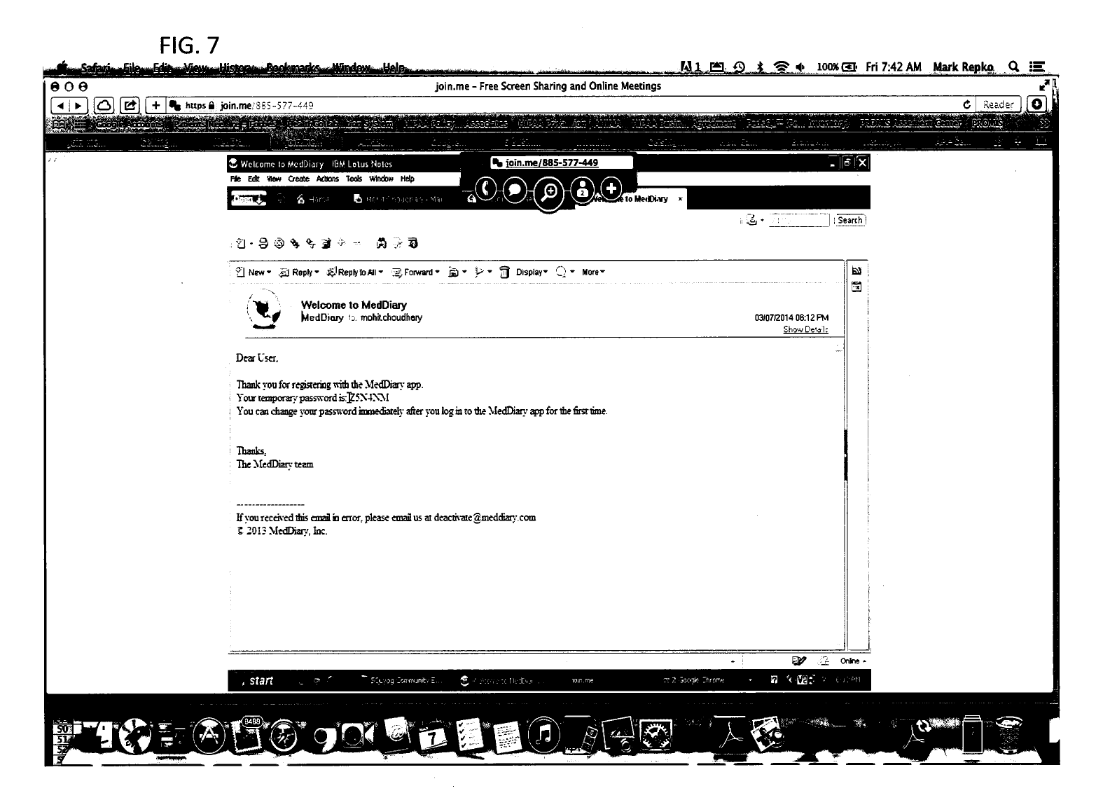

In at least one embodiment of the present disclosure, the provider will not be provided access to a patient record until the patient approves such access in step 104. In such an embodiment, the patient receives a communication from the system indicating that the provider has requested access to the patient's records within the system. In such an embodiment, the patient may access or reject the provider's request through the communication or by interacting with the communication to access the system. An exemplary communication is shown in FIG. 6. As shown in FIG. 6, the patient Mohit Choudhary is sent an email by the system indicating that a specific provider, Martin Rack, has requested access to the patient's record. In this example, the communication provides a link to the patient to download a mobile application for further interaction with the system. Upon downloading and interacting with the mobile application, the patient may register an account and receive a unique identifier in a second communication, such as the communication shown in FIG. 7.

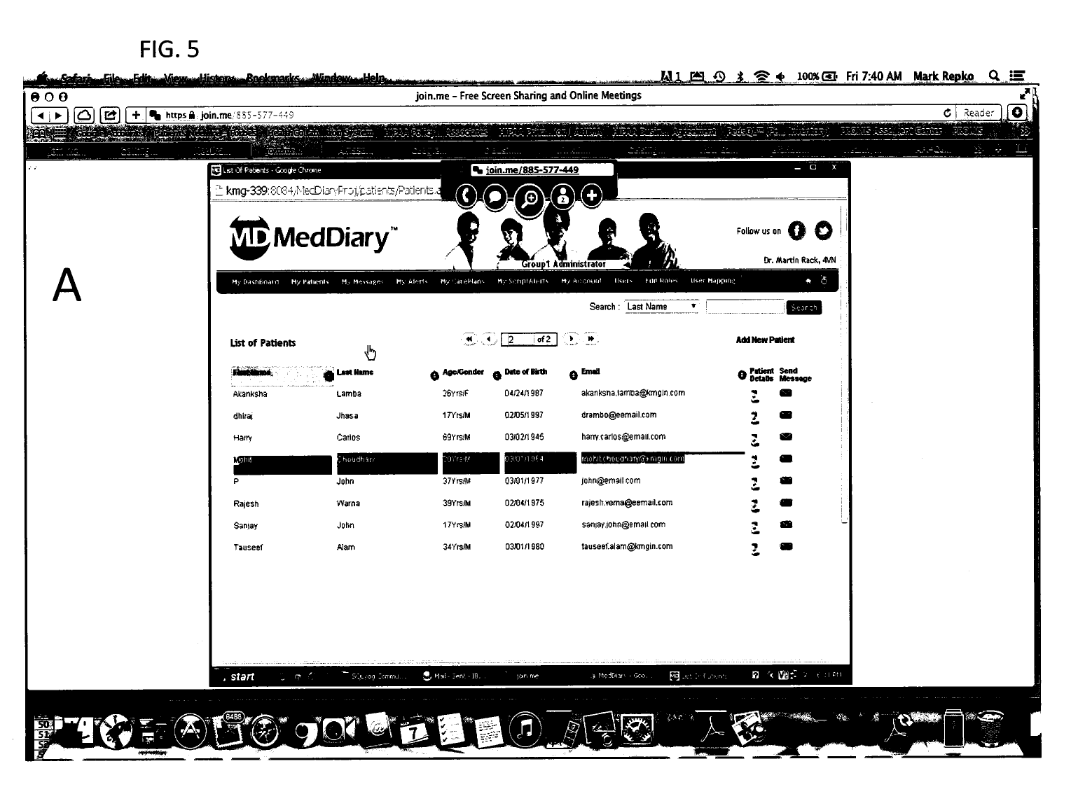

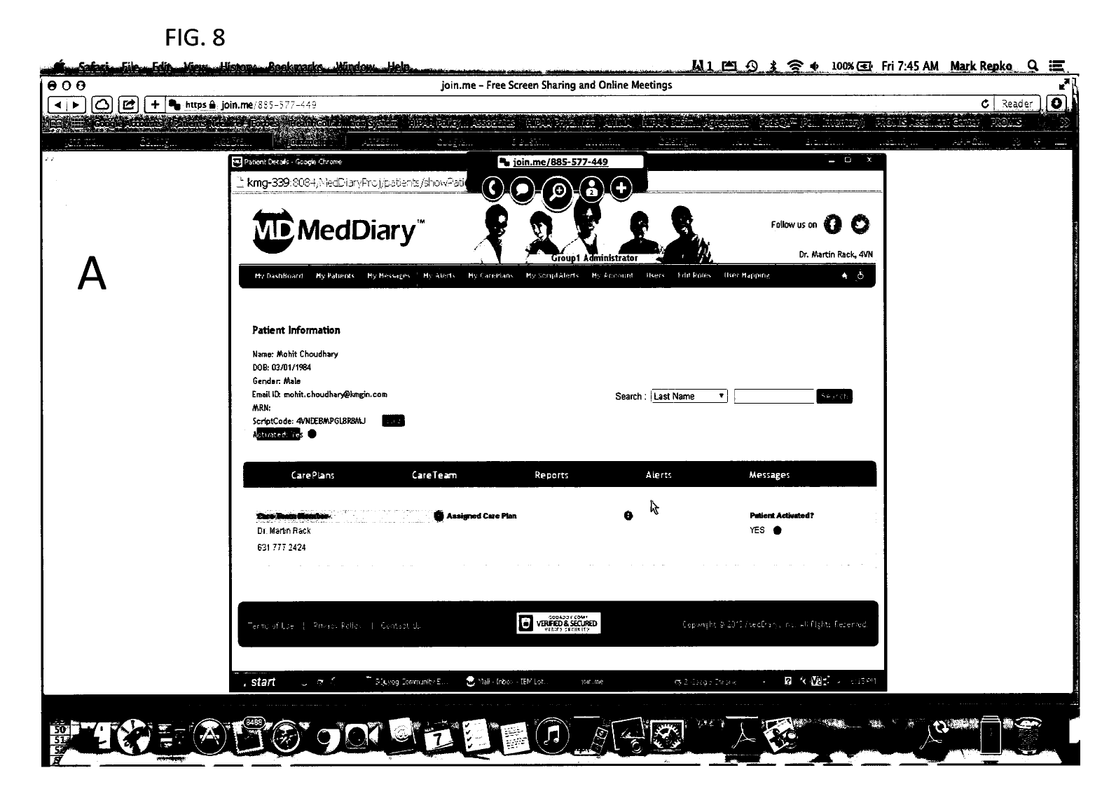

Upon the patient accepting the provider's request in step 104, the provider is granted access to the patient's record within the system. For example, as shown in FIG. 5, the provider may have requested access to Mohiti Choudhary which is now displayed in his list of current patients after Mohiti Choudhary accepted such request. In addition, the provider may also view all providers with access to the patient's record in the system. As shown in FIG. 8, in this ongoing example, the only provider with access is Dr. Martin Rack.

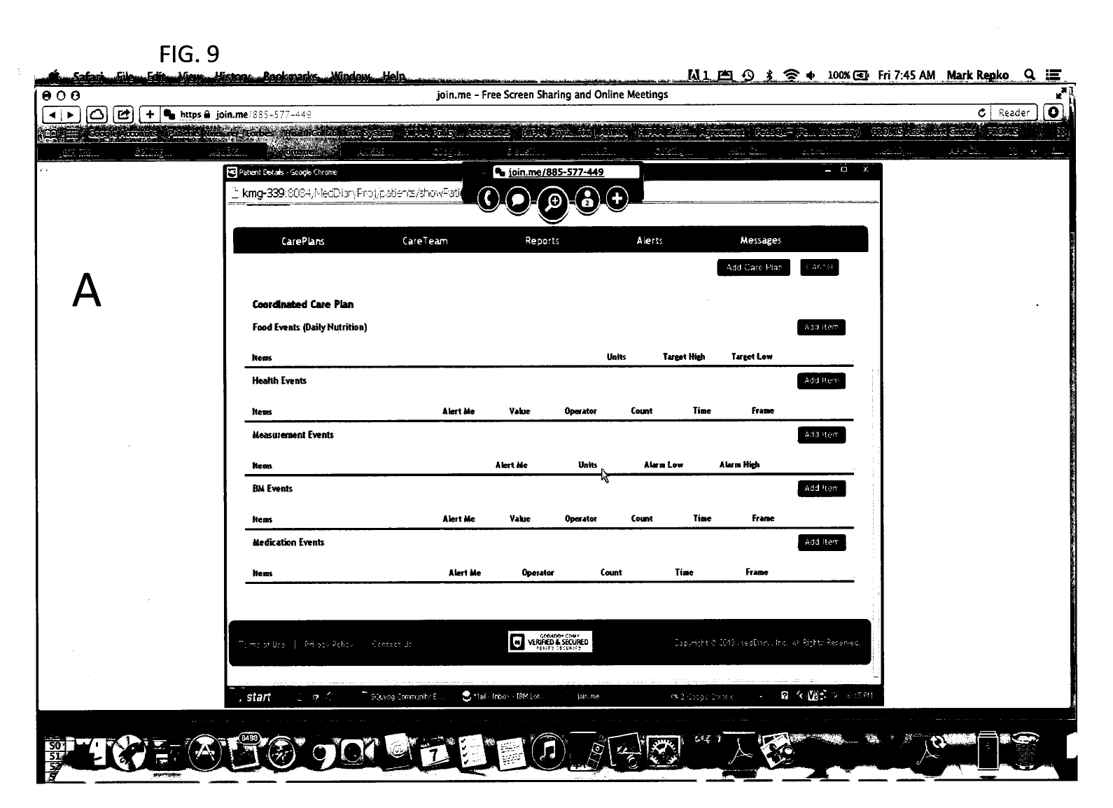

In at least one embodiment of the present disclosure, a provider with access to a patient record may configure a health care plan in step 106. As used in the present disclosure, a health care plan is a set of measured health attributes, symptoms, proscribed medication and other characteristics of a patient in which a health care provider is interested in monitoring in order to ascertain a patient's status concerning a managed chronic or lifelong illness. Based on the monitored attributes and information, the provider, through the health care plan, may proscribe additional medications, request that the patient schedule an appointment with the provider, or even request that the patient seek immediate medical attention. When configuring the health plan in step 106, the provider may be presented with an option to add a variety of attributes, such as, for example, those shown in FIG. 9—food events, health events, measurement events, bowel movement events, medication events, and other items. It should be appreciated that the categories shown in FIG. 9 are merely examples and that additional information and/or measured attributes may be configured within the system.

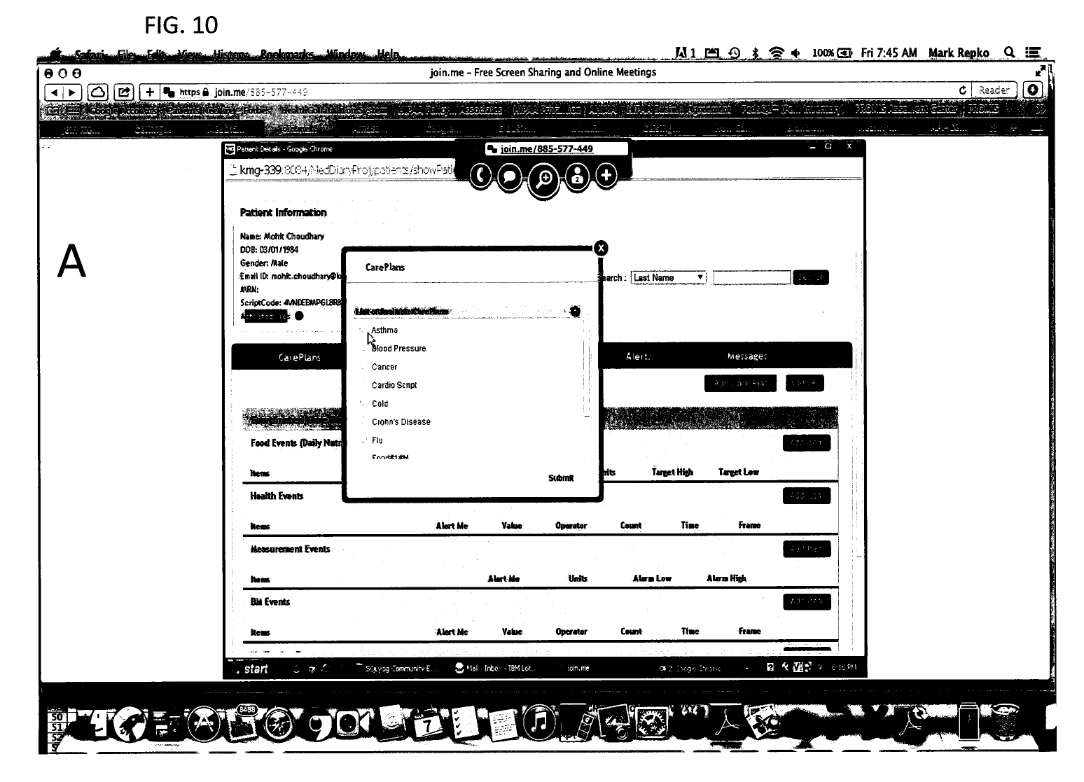

In some embodiments, a system may be preconfigured with commonly used health care plans, like asthma, diabetes, high blood pressure, cancer, cardio script, cold, Crohn's disease, flu, and others, such as, for example, as shown in FIG. 10. In such an embodiment, the preconfigured health care plans may automatically populate a list of monitored attributes, symptoms, and proscriptions for the patient when added to the patient's profile. For example, a preconfigured health care plan for diabetes may automatically add monitors for a patient's daily caloric and carbohydrate intake and symptoms of swelling legs. In this example, in the event that any values monitored by the system within these measured health attributes and symptoms could generate an alert to the provider for follow up with the patient. It should be appreciated that the alarming values may be preconfigured with the health care plan and/or manually entered by the provider when configuring the health care plan.

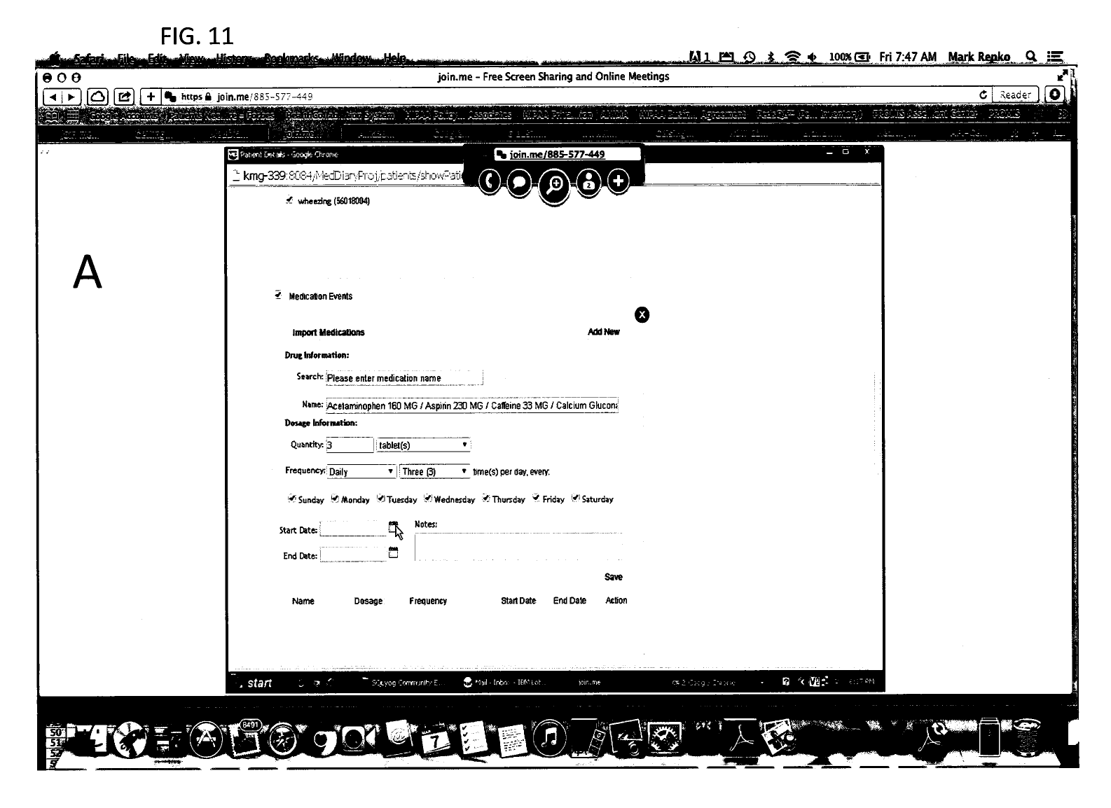

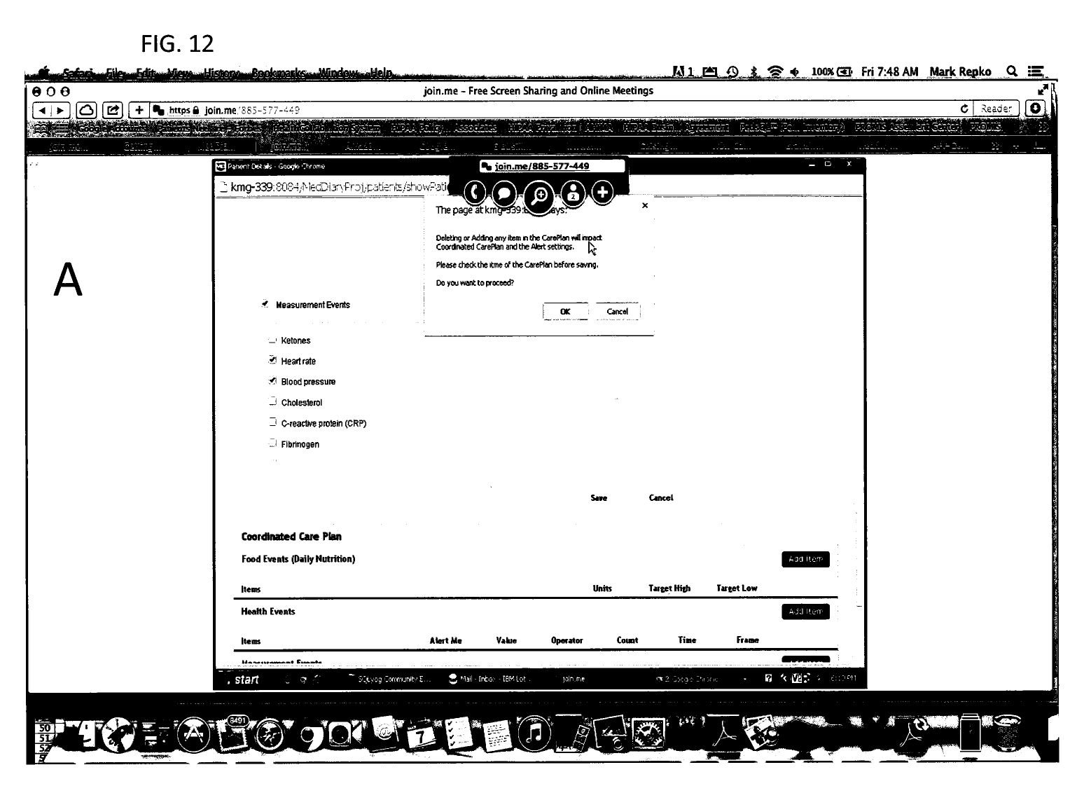

In at least one embodiment of the present disclosure, a provider may add additional items to a health care plan, remove items from a health care plan, alter settings within a health care plan, or generally administrate a health care plan. For example, as shown in FIG. 11, a provider may add medication to a health care plan for asthma. In this example, the provider proscribes Acetaminophen at 160 MG, Aspirin at 230 MG, Caffeine at 33 MG, and other medications. In this example, the provider sets the quantity for consumption to three at an interval of three times per day every day of the week. It should be appreciated that the provider may proscribe multiple medications at varying intervals and that the example shown in FIG. 11 is merely an example. Upon saving the added medication, the provider may be prompted with a pop-up message or other notification requesting verification before proceeding in modifying the health care plan, such as the message shown in FIG. 12.

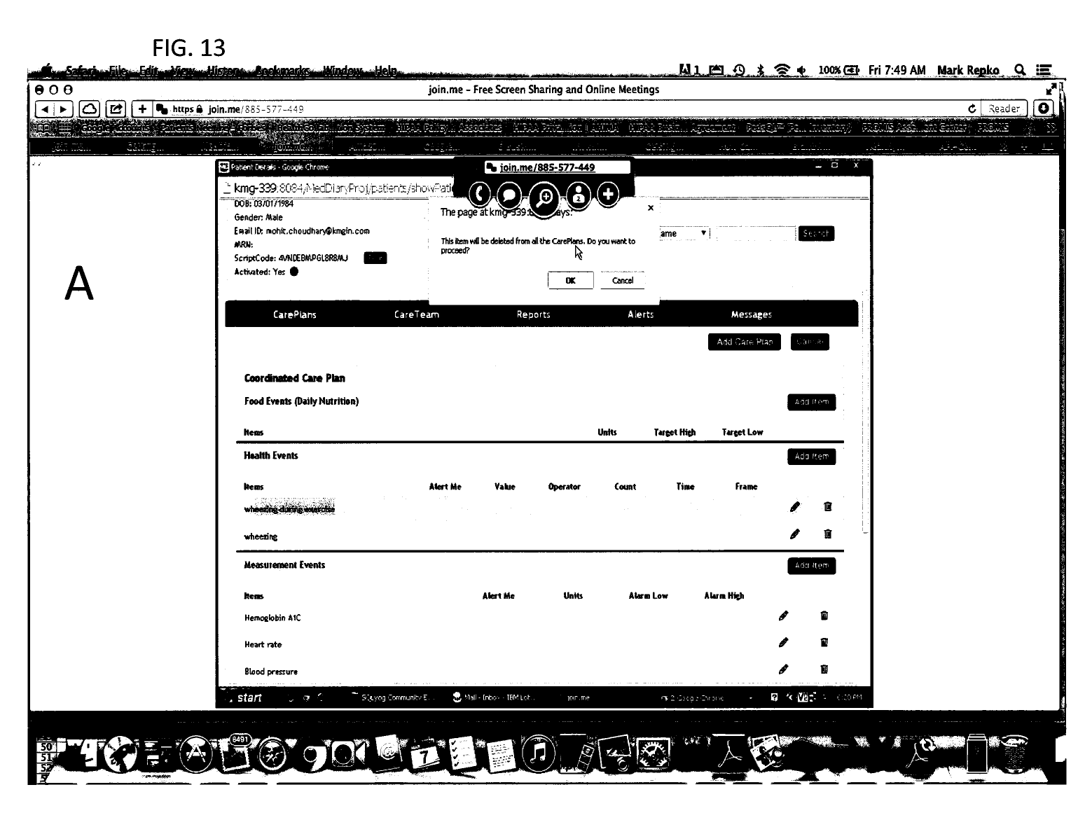

It should be appreciated that the provider may delete attributes monitored by a health care plan assigned by the provider. It should be appreciated that a provider deleting attributes monitored by a health care plan assigned by the provider will delete such attributes as monitored by any other health care plan for the patient, including attributes monitored by other providers within the system. This “global delete” enables a provider to remove monitoring a measured health attribute, symptom, or other information when the health care plan is no longer relevant to the patient. For example, a provider configuring a health care plan for a common cold may add a symptom of “runny nose” for monitoring. In the event that a patient reports a runny nose through his or her electronic device, the provider's health care plan may be configured to alert the provider to provide follow up care. In this example, when the patient is no longer suffering from the common cold, the provider may delete monitoring of a runny nose from the system, which will delete all monitors of runny nose for the patient from all health care plans. In another example, as shown in FIG. 13, a provider may delete a monitored attribute in a health care plan for a chronic illness, like wheezing during exercise in association with a health care plan for asthma.

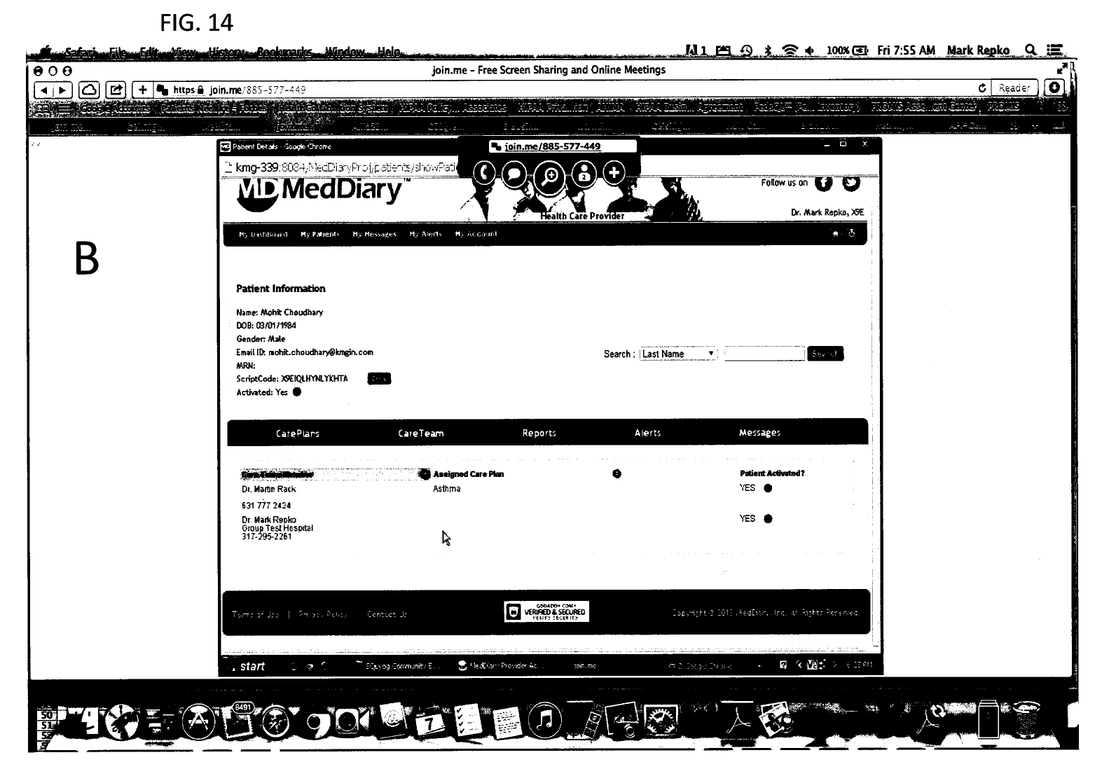

In at least one embodiment of the present disclosure, the method 100 includes a second provider requesting access to a patient in step 108. In such an embodiment, the second provider may be desirous of monitoring a second chronic or lifelong illness for a patient and, therefore, request access in step 108. It should be appreciated that the system may be configured to enable a second provider to request access in the same manner as the first provider requested access in step 102. In addition, the patient may authorize access to the second provider in step 110 in the same manner as the patient authorized access to the first provider in step 104. In such an embodiment, after authorizing access to the second provider, the second provider is added to the patient's care team and may add, remove, or alter health care plans for the patient. For example, as shown in FIG. 14, the second provider, Dr. Mark Repko, is shown in the care team for the patient.

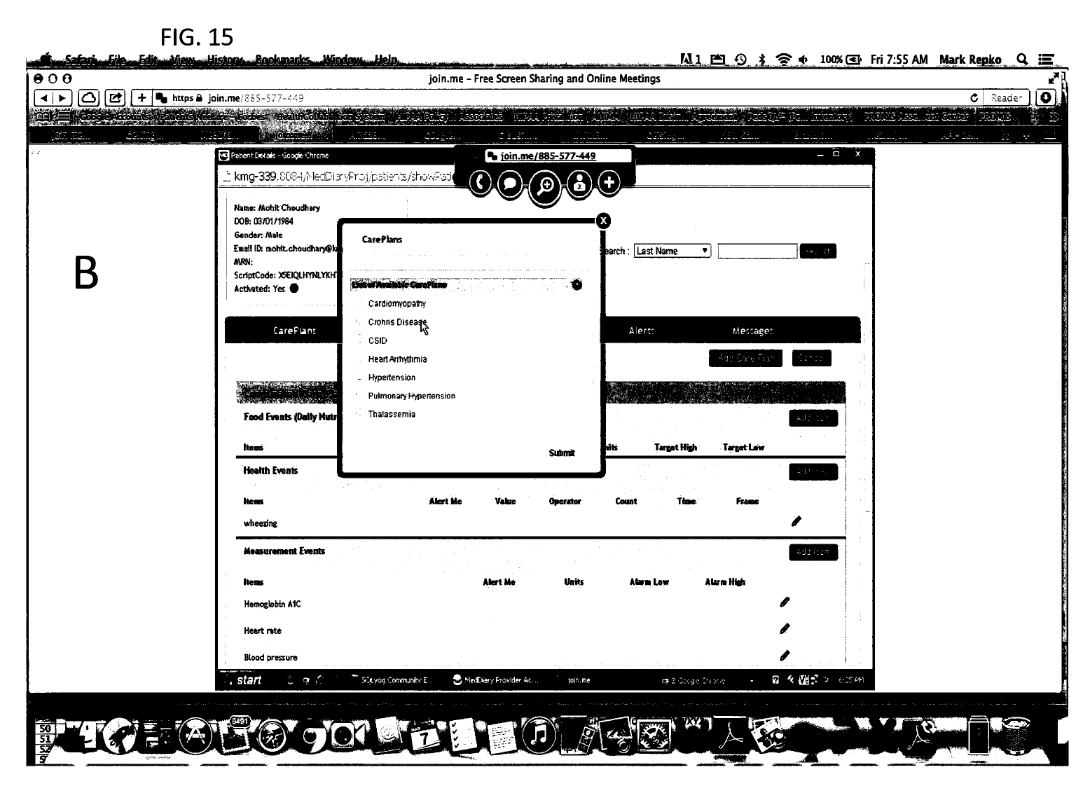

In this example, Dr. Repko has not assigned any health care plans to the patient. In at least one embodiment of the present disclosure, the second provider may add health care plans for the patient in step 112. In such an embodiment, the second provider may add health care plans similar to the health care plans added by the first provider in step 106. In such an embodiment, the second provider may add preconfigured health care plans, such as those shown in FIG. 15 or otherwise configured within the system. The provider adding additional health care plans will coordinate with health care plans adding by other providers to create a single coordinated care plan among all providers in step 114. In such an embodiment, the coordinated care plan includes all monitored measured health attributes, symptoms, and other information about the patient with all created triggers and alarms by individual providers.

For example, referring to FIG. 15, when Dr. Repko is given authorization to view the patient's information and current health care plan, Dr. Repko may see that the patient, in this example Mohit Choudhary, is already being monitored for wheezing as a symptom with measured events monitoring his Hemoglobin, heart rate and blood pressure. In this example, when Dr. Repko adds an additional care plan, this care plan will integrate with the previously configured alarms and monitors by other providers to create a coordinated care plan.

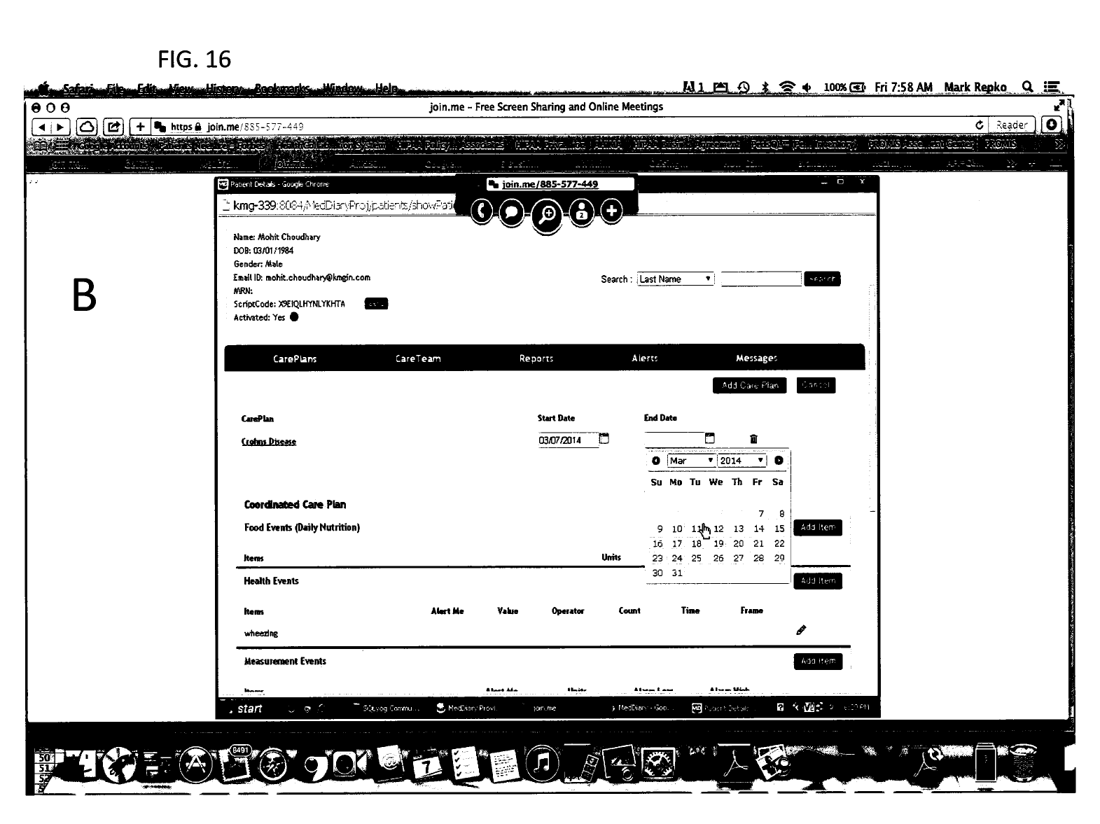

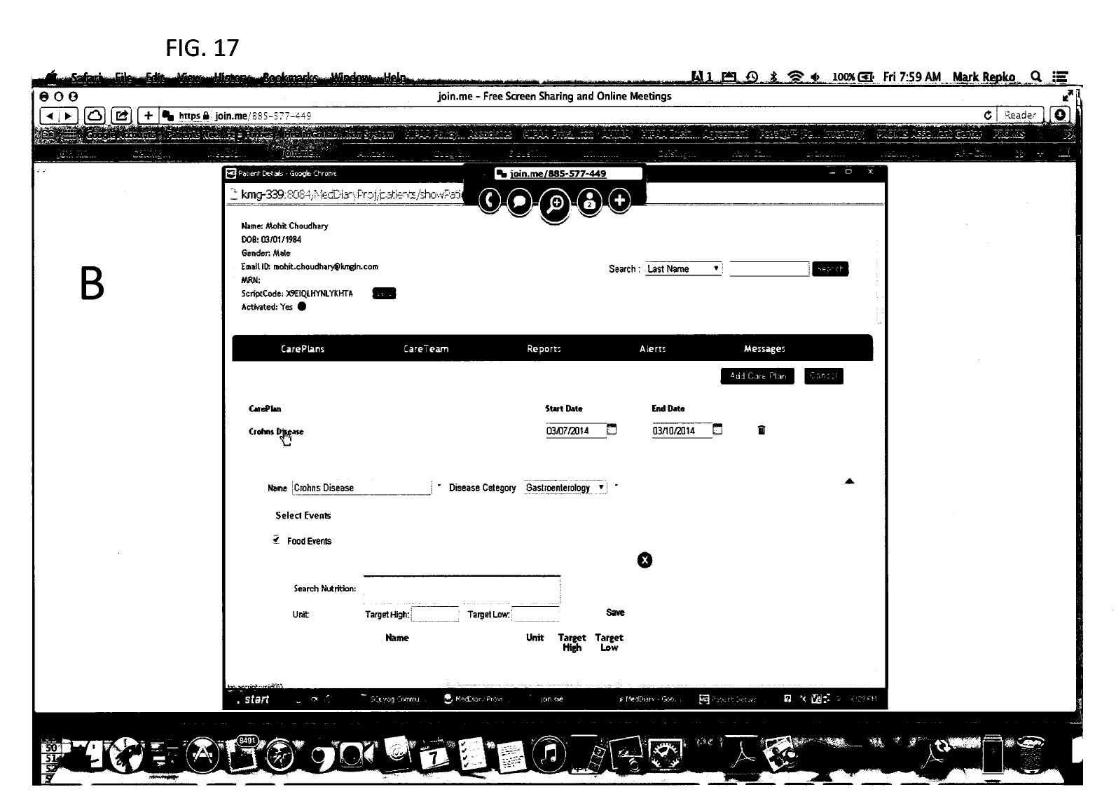

In at least one embodiment of the present disclosure, individual health care plans for specific illnesses may integrate with the coordinated care plan over a period of time as they are added by a provider or removed by a provider. In addition, as shown in FIGS. 16 and 17, a provider may configure a health care plan to only be active for a period of time with a preconfigured start date or end date. Upon the preconfigured expiration date, the health care plan and associated triggers, alarms, and monitors will be removed from the coordinated care plan as appropriate. It should be appreciated, of course, that a start date and end date are not required.

In at least one embodiment of the present disclosure, individual health care plans may be created that create integrated, but removable, layers of specifications for the patient's overall coordinated health care plan. In such an embodiment, a provider may create a specialized health care plan for a specific disease, like diabetes, with specific triggers, monitors, and other attributes that are important for caring for diabetes. In this example, as the provider makes changes to the individual diabetes health care plan, he or she does not alter other health care plans also being monitored for the patient, like an asthma health care plan. It should be appreciated that the layered approach provides added benefits for a patient suffering comorbidities such that each disease may be managed individually through an individual health care plan but integrated together in a coordinated health care plan with a single view for each provider.

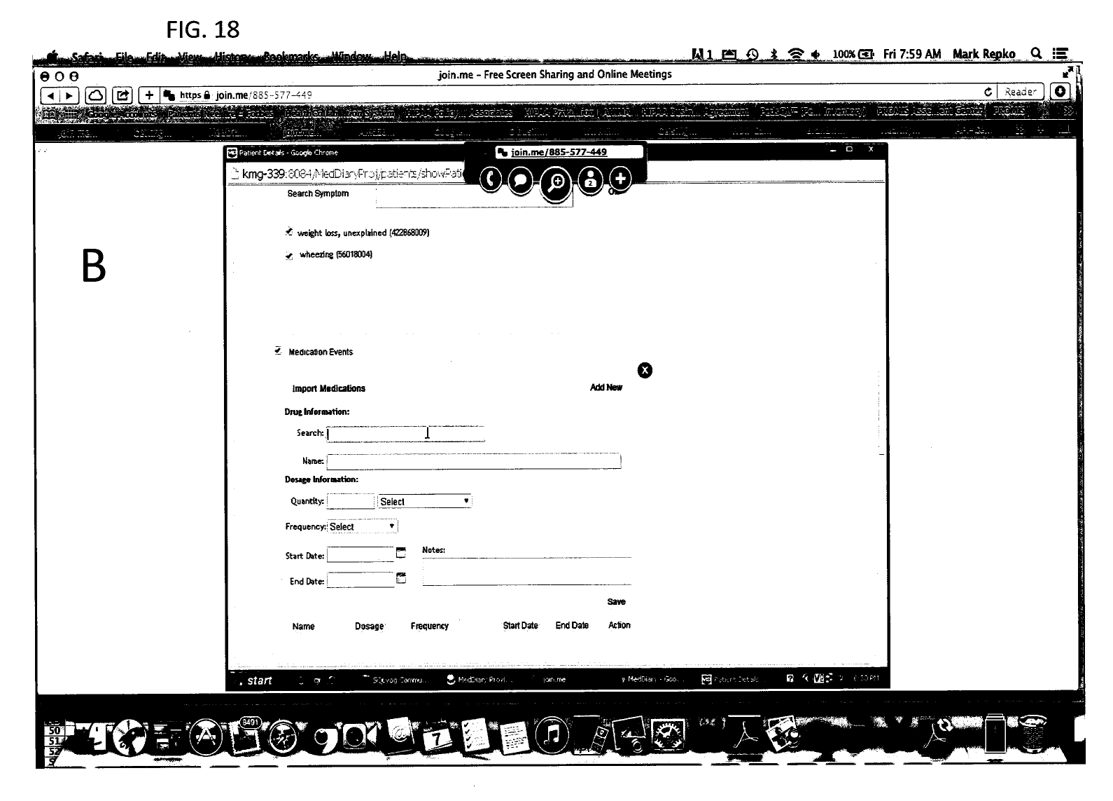

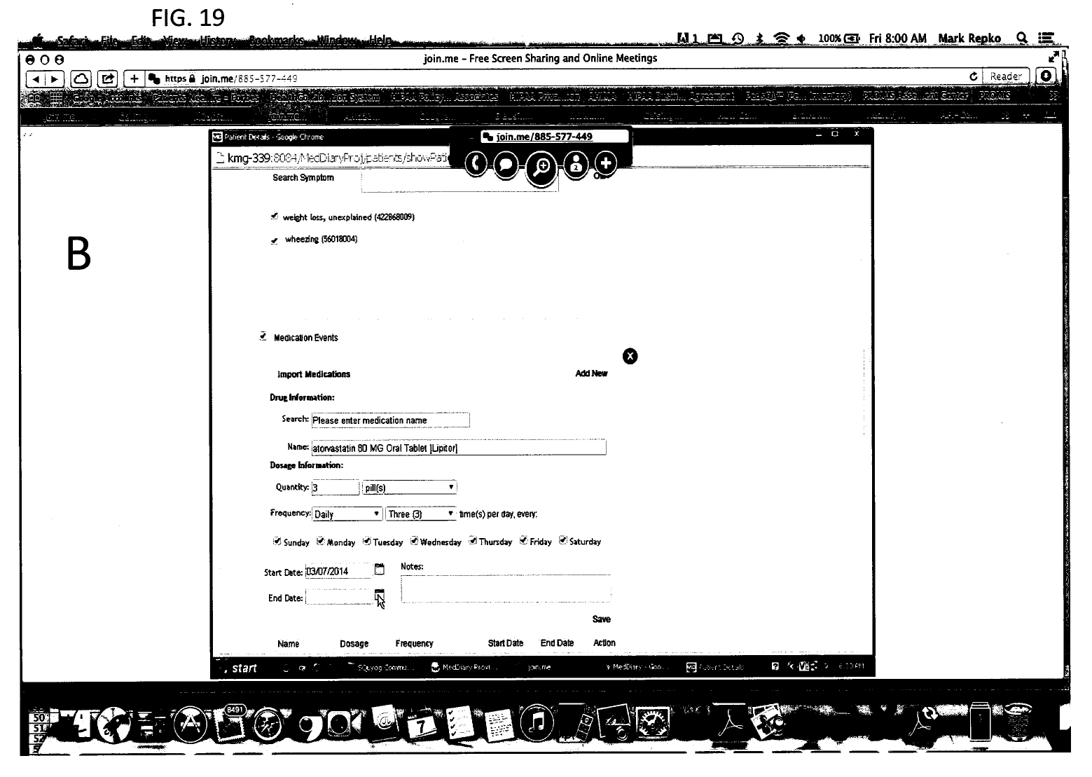

As part of a health care plan, a provider may proscribe medication. In such an embodiment, the provider may import medications from preconfigured health care plans, an electronic health record, or other resource or, alternatively, the provider may manually enter medication for proscription, a frequency for the patient to take the medication, a dosage, a start date, an end date, and any notes for the medication. The provider may input such medication in freeform text, such as, for example, through a graphical user interface as shown in FIGS. 18 and 19.

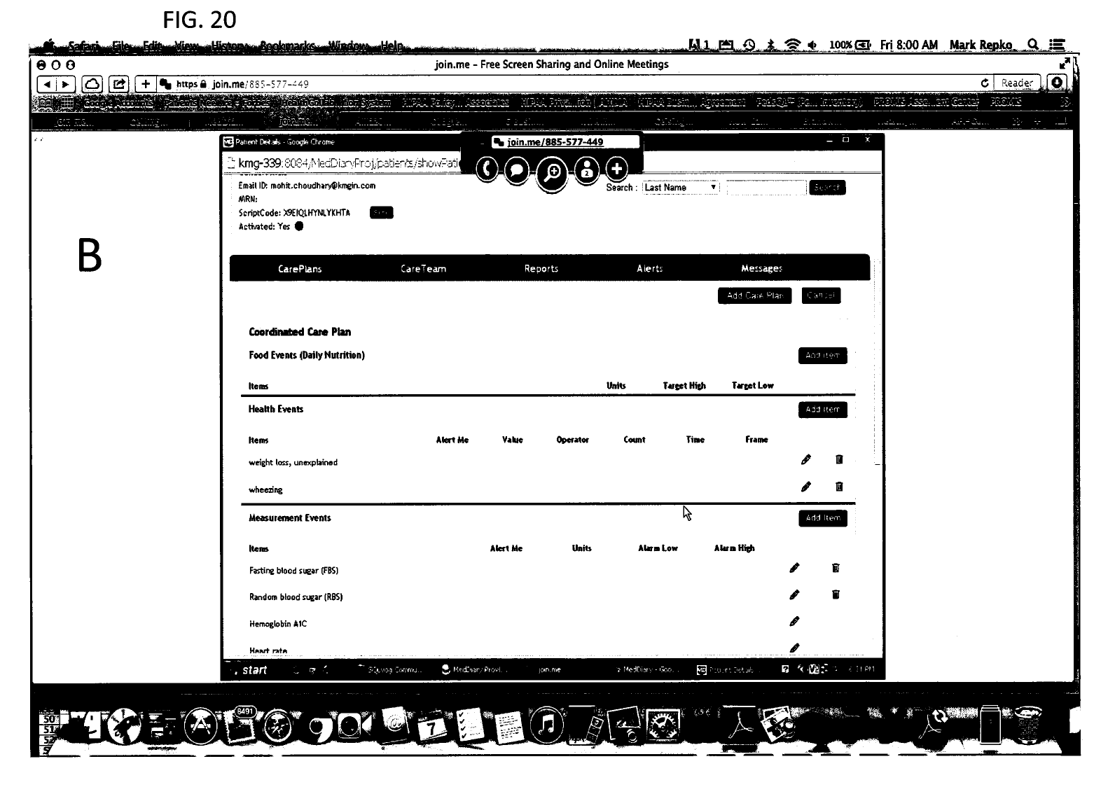

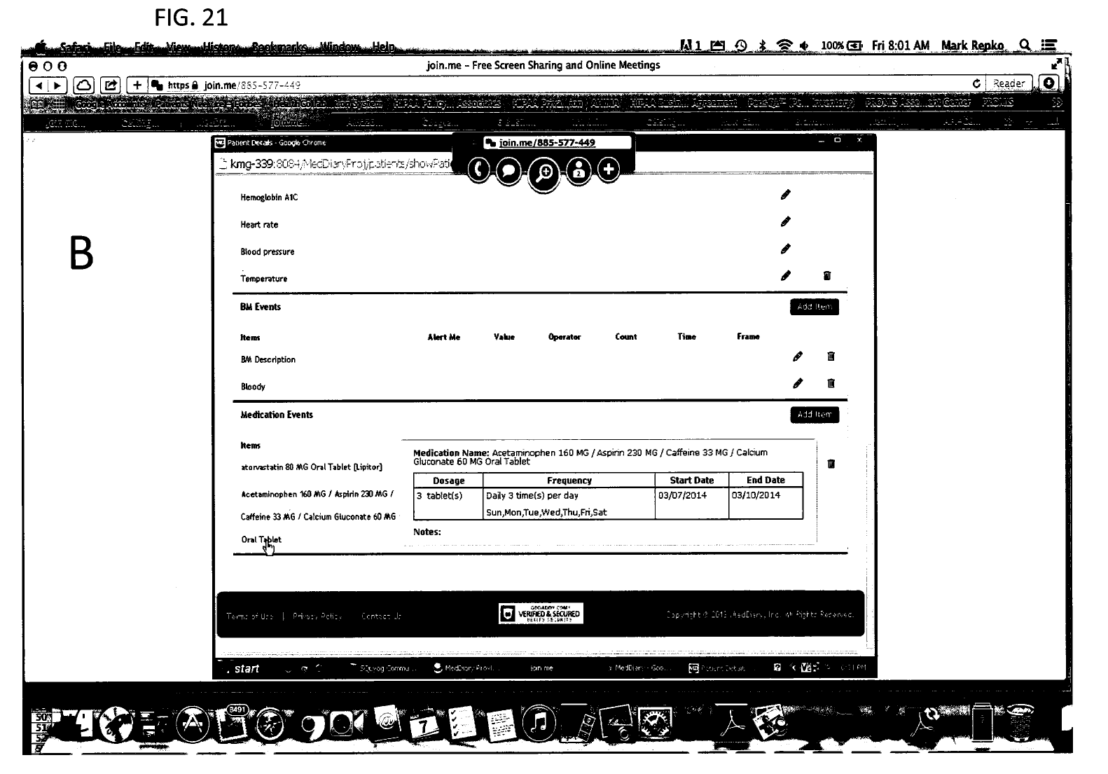

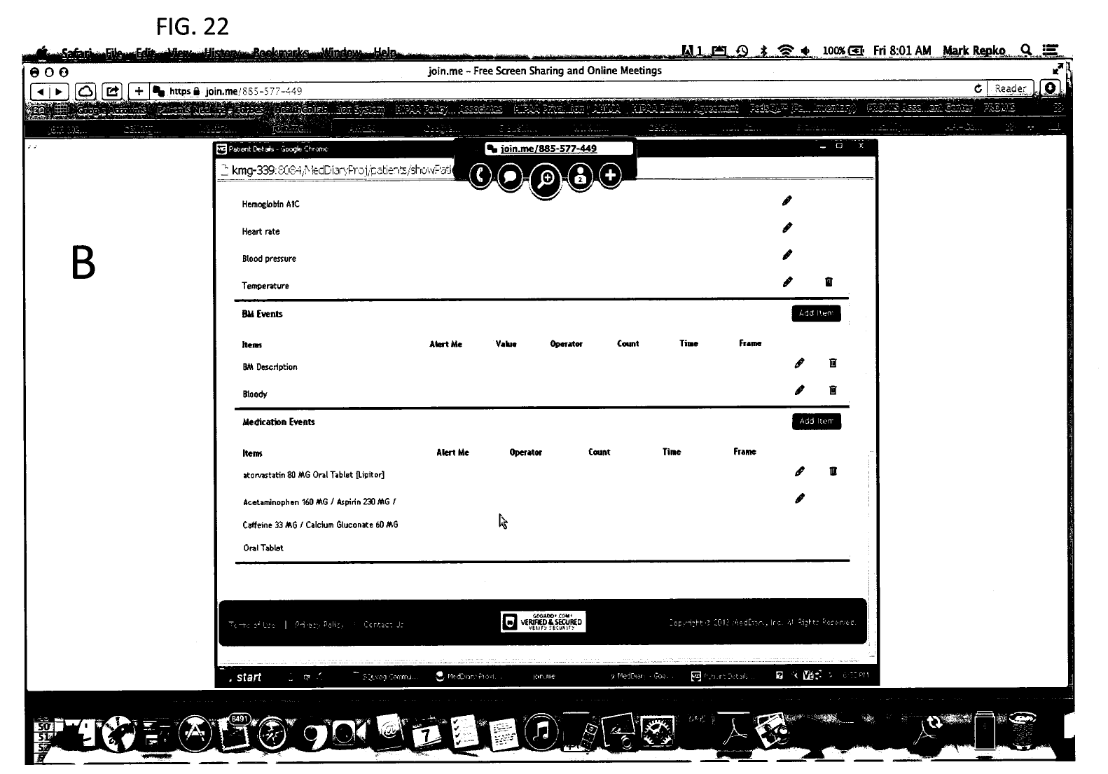

An example of a coordinated health care plan for a patient with comorbidities is shown in FIGS. 20, 21, and 22. As shown in FIG. 20, a coordinated health care plan includes monitoring health events associated with unexplained weight loss, wheezing and measured events for fasting blood sugar, random blood sugar, hemoglobin, heart rate, and others. It should be appreciated that when the coordinated health care plan is viewed by a provider, the provider may not have access to remove all monitored events. For example, as shown in FIG. 20, the provider viewing the coordinated health care plan cannot the monitored event for hemoglobin or heart rate, presumably because these measurement events were added by a different provider. In addition, as shown in FIG. 21, the provider viewing the coordinated health care plan cannot remove any proscribed medication except Lipitor. Of course, in order to provide accurate care and proscribe medication that will not conflict with other medication, the provider viewing the coordinated health care plan may view all proscribed medication.

In at least one embodiment of the present disclosure, the method 100 includes altering providers based on patient activity and health plans in step 116. In such an embodiment, each provider with access to a patient may use any monitored and/or measured events within the coordinated health care plan to generate alerts to the provider. It should be appreciated that these alerts may be generated based on different thresholds for different attributes and/or different providers. For example, a first provider may create an alert in the event that a patient cannot maintain a caloric intake of 2000 calories in a single day. In this example, a second provider may only alert if a patient cannot maintain a caloric intake of 1000 calories in a single day. In this example, in the event that that the patient records a caloric intake of 1500 calories in a single day, the first provider will receive an alert whereas the second provider will not receive an alert because the 15000 calorie intake is above the second provider's threshold for alerting.

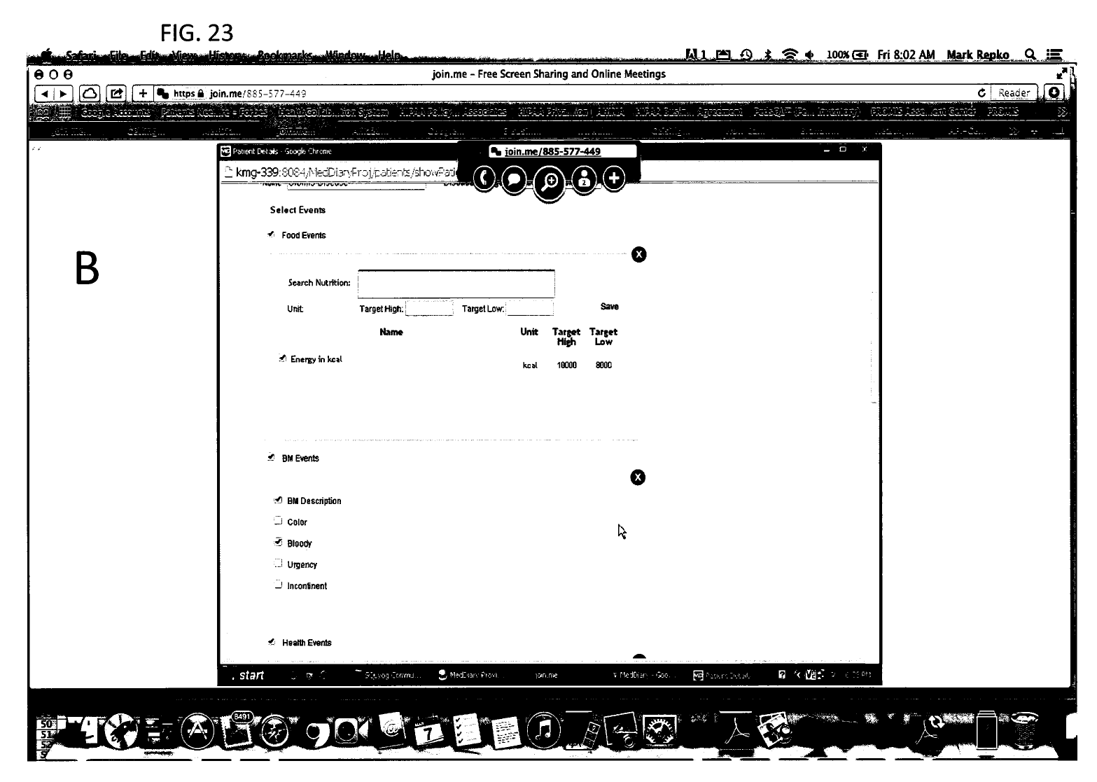

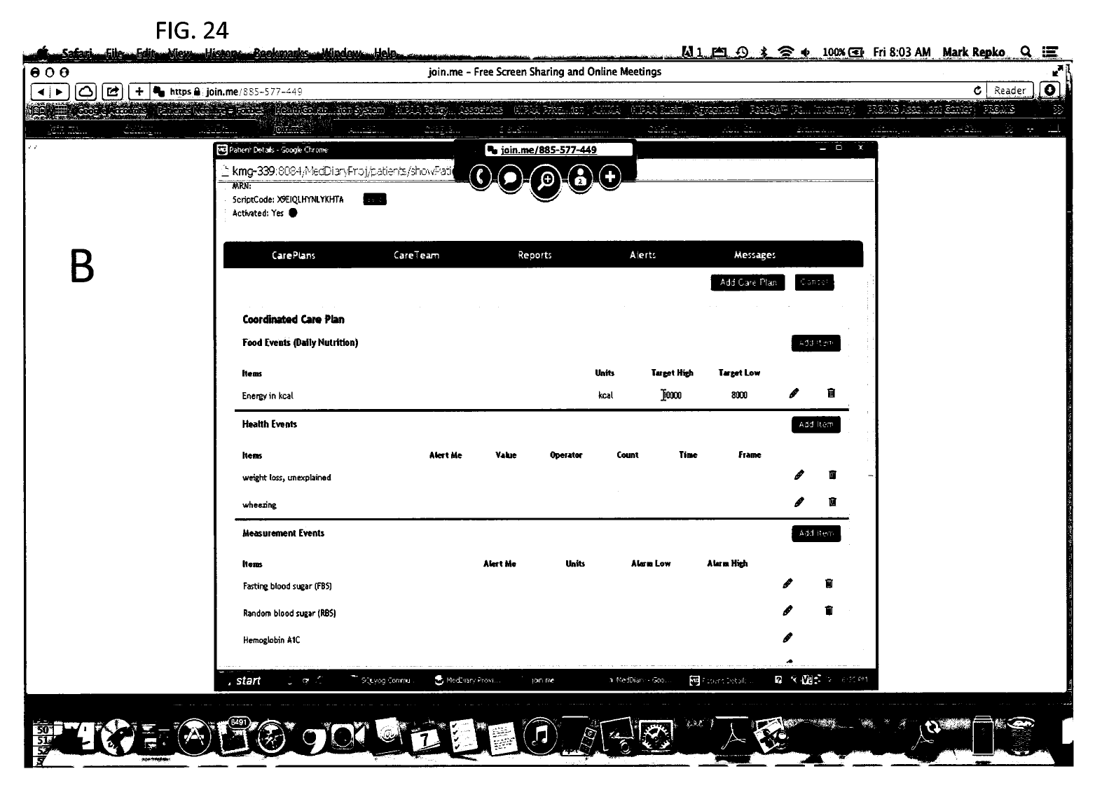

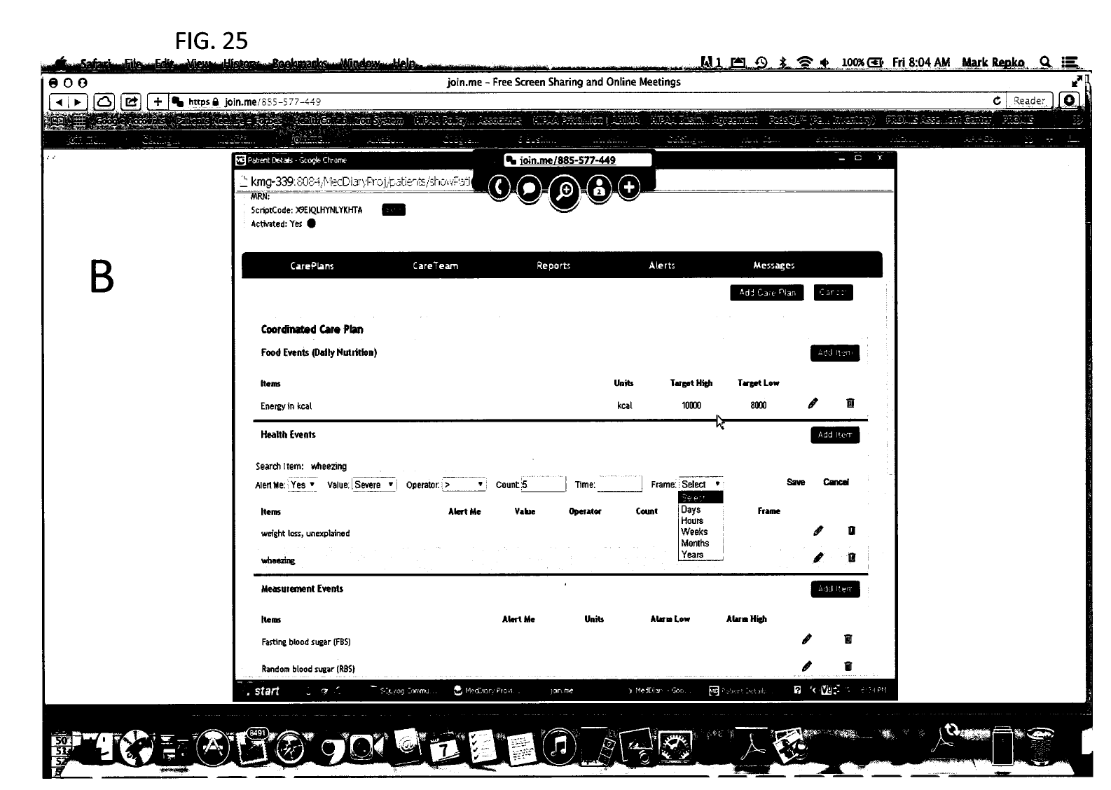

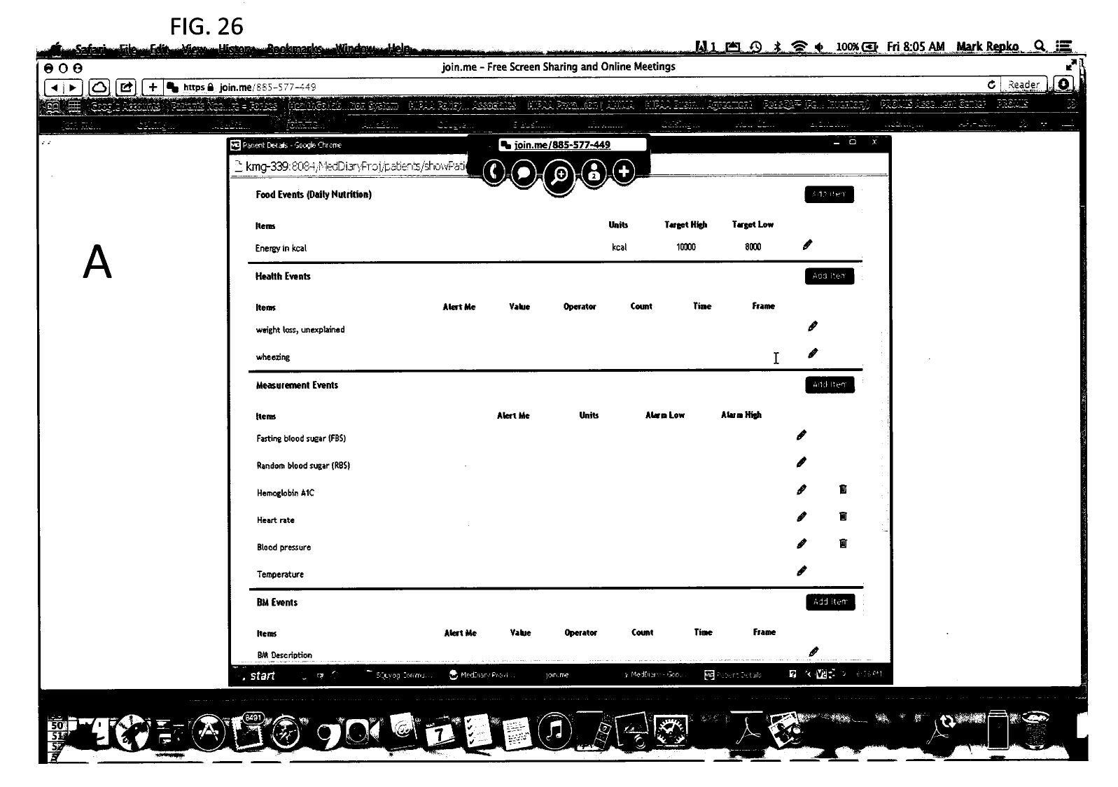

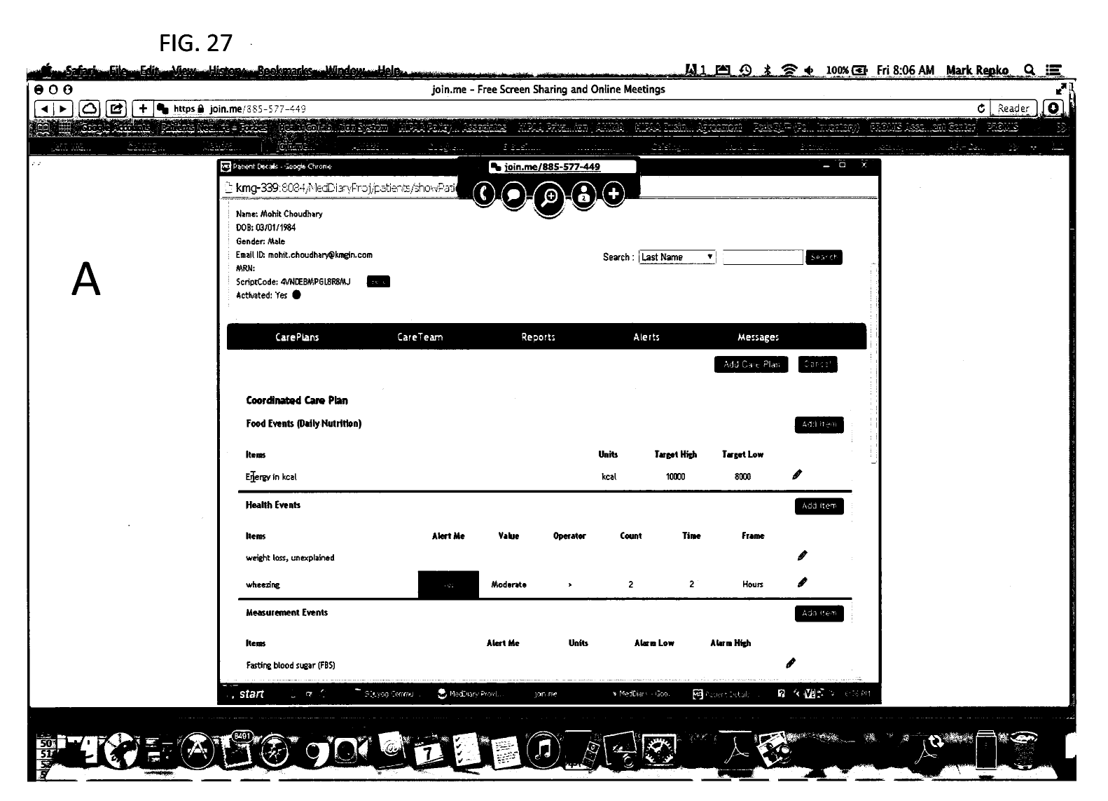

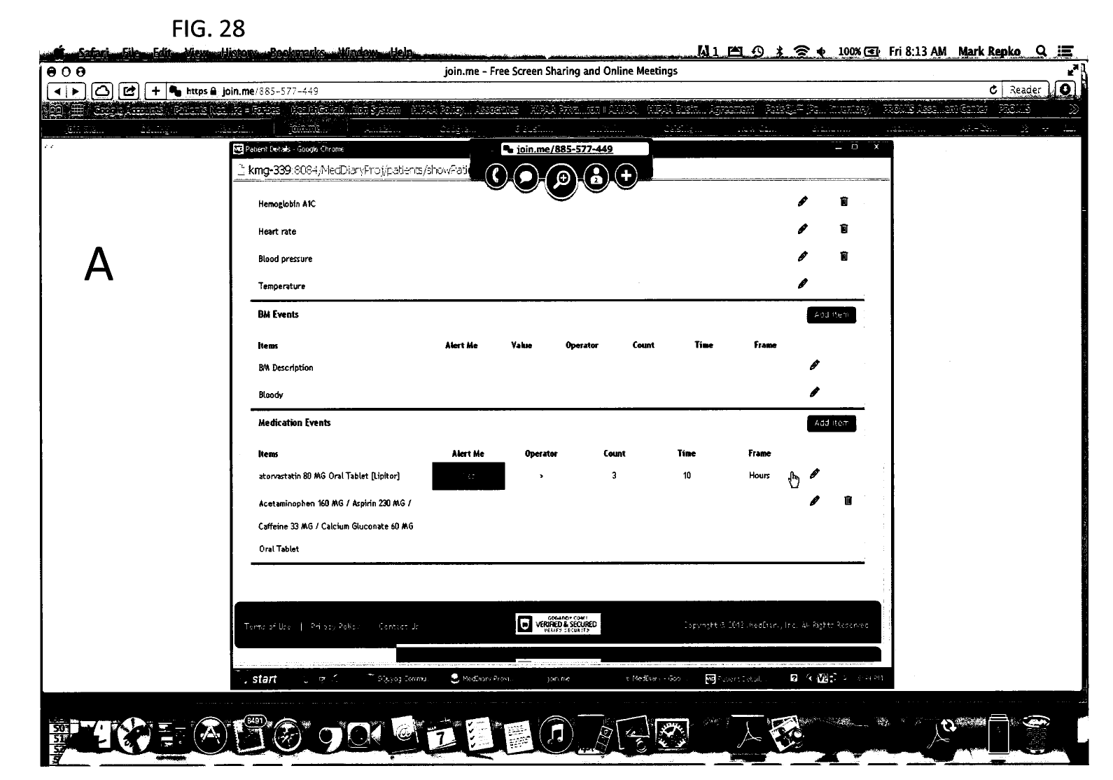

It should be appreciated that alerts may be generated in any number of ways, including a communication. An alert may also generate a telephone call or ticket to an on-call provider, nurse, or other representative for resolution. For example, as shown in FIG. 23, a provider may create an alert based on a measured attribute, like energy in kilocal with a low threshold of 8000 and a high threshold of 10000. In this example, in the event that the patient shows an energy level outside of this 8000-10000 range, the system will generate an alert. As shown in FIG. 24, this monitor and associated alert may be shown on the coordinated care plan. FIG. 25 shows an additional example of an alert. It should be appreciated that alerts may be created for proscribed medication, measured events, food events, and any item managed by the coordinated health care plan, for example, as shown in FIGS. 26-29. In a preferred embodiment each provider may set individual alerts with individual thresholds that are not seen by other providers.

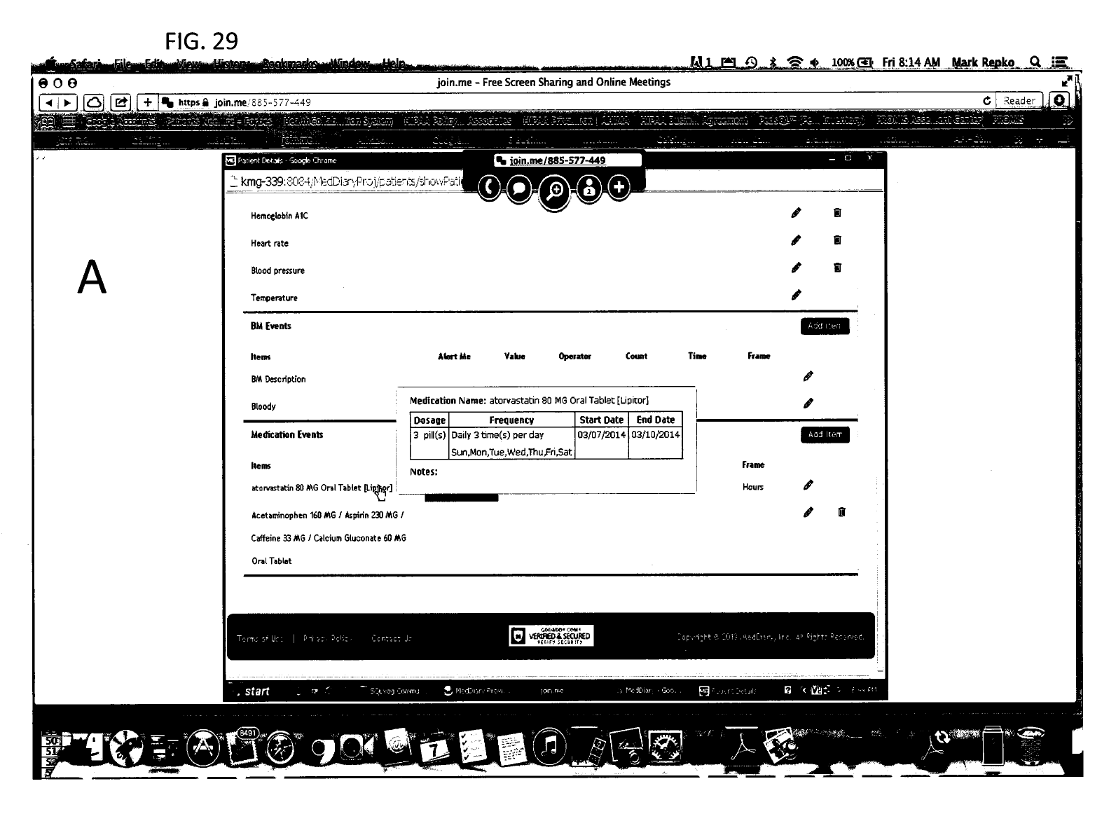

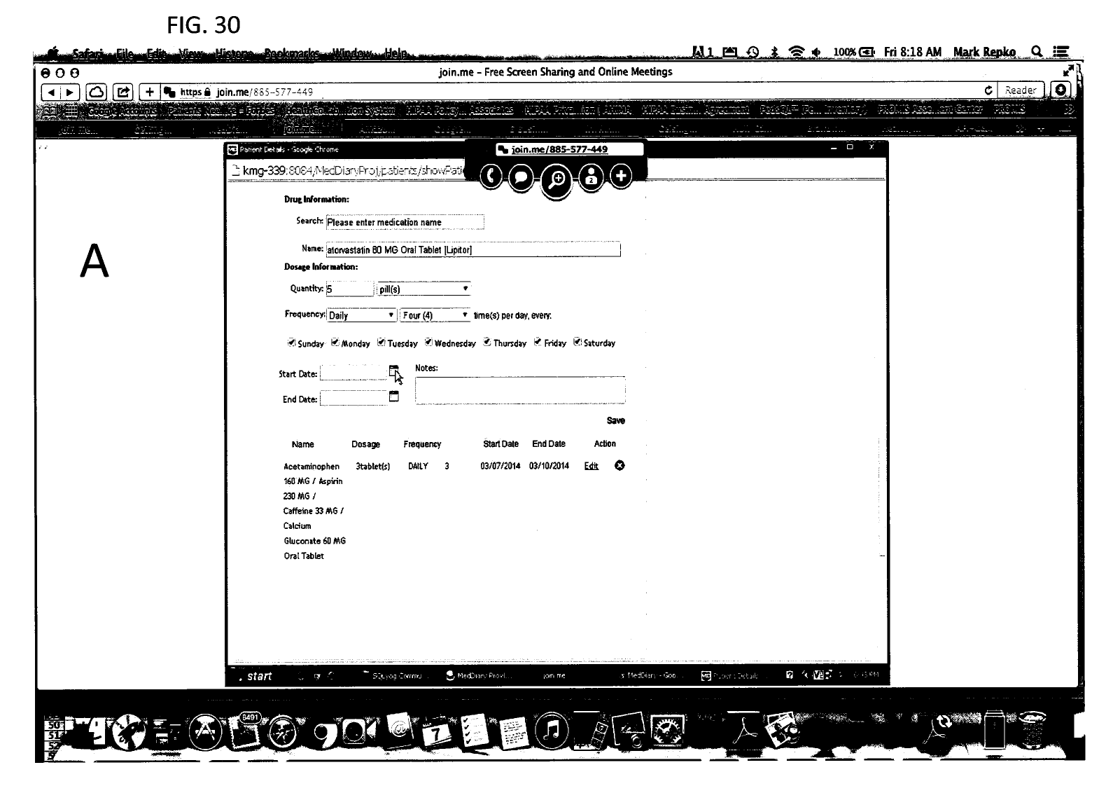

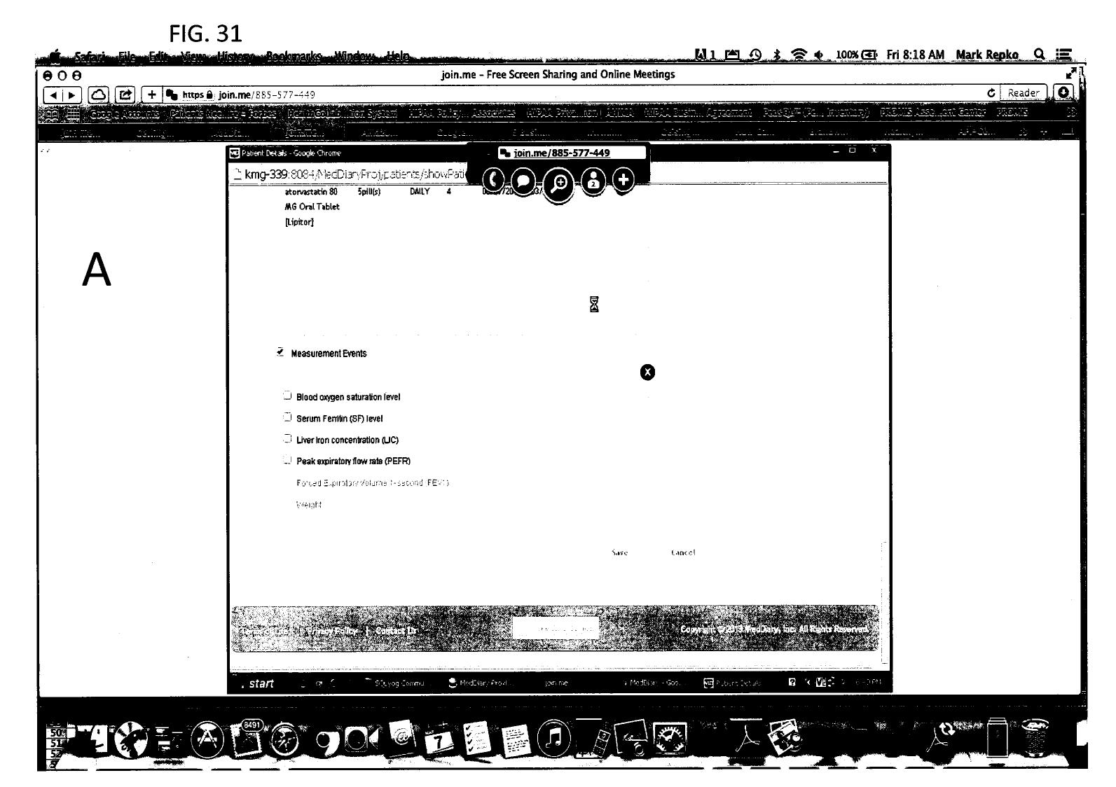

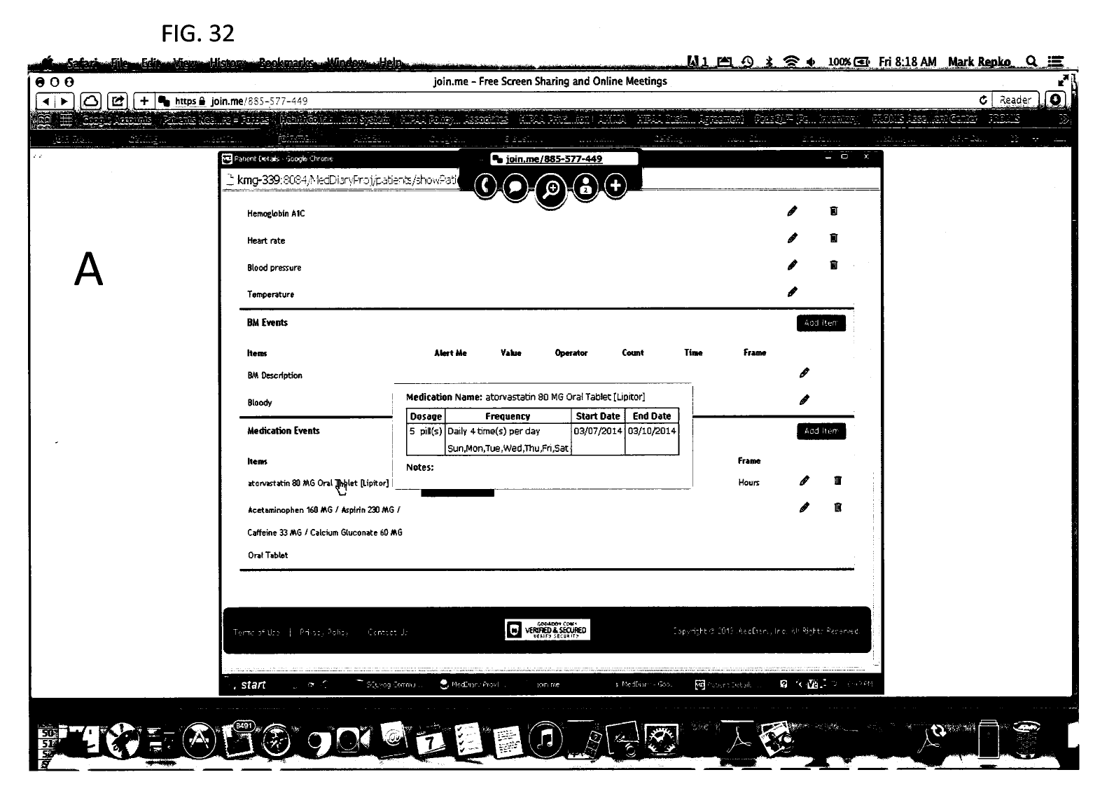

In at least one embodiment of the present disclosure, a provider may overwrite medication proscribed by another provider. In such an embodiment, a provider treating a condition may evaluate the entirety of a patient's coordinated care plan and associated chronic illnesses and, in the provider's discretion, alter proscribed medication to fit the patient's needs and/or avoid medication conflicts. For example, a provider managing a patient with a proscription for Lipitor may alter a previously proscribed dosage of the medication by another provider because of a new managed illness or other measured attributes of the patient. One such example is shown in FIGS. 29-32.

In at least one embodiment of the present disclosure, a provider may create and add a health care plan for a patient before receiving authorization from the patient to proceed. In such an embodiment, the provider cannot actually see a patient's profile within the system but may create a health care plan for the patient that will be automatically activated upon receiving the patient's authorization in the system. It should be appreciated that this process is advantageous because it enables a provider to add a patient and create a health care plan without waiting for a patient to authorize the provider's request and, when finally authorized by the patient, the patient may immediately start receiving care from the provider through the automatically added and activated health care plan.

It should be appreciated that a provider may associated himself or herself to a patient in steps 102 and 104 or steps 108 and 110 but not create any health care plans in step 106 or 112. In such an embodiment, the provider may be interested in seeing what health care plans have been assigned to the patient for monitoring purposes. For example, a general practitioner that works with a patient may be desirous to see all care being provided to the patient in order to provide appropriate advice, proscribe non-conflicting mediation, or other health care activities in the event that the patient schedules an appointment for an unrelated health issue to what is being monitored in the system.

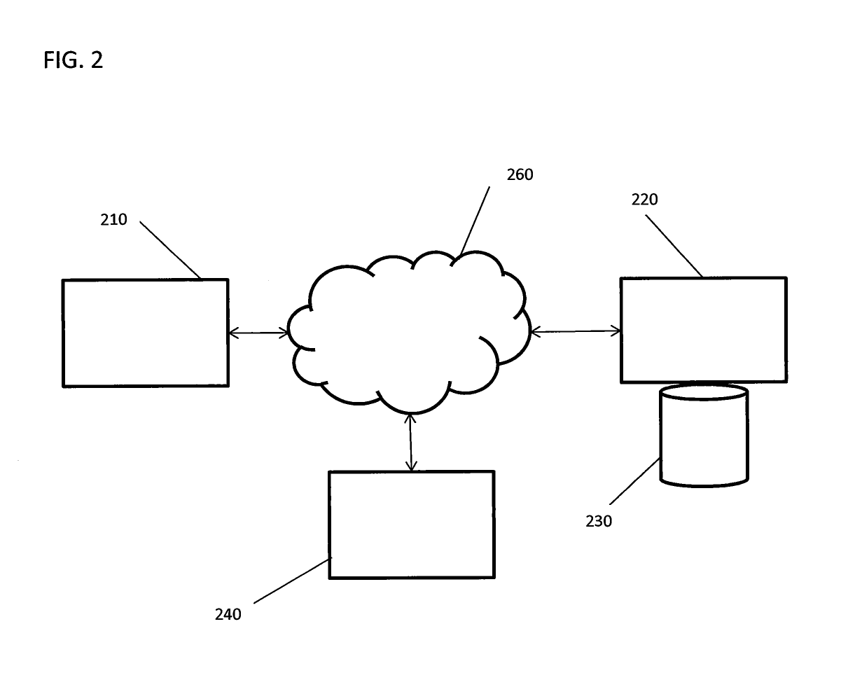

Referring now to FIG. 2, there is shown at least one embodiment of the components of the system 200 for coordinating health care plans according to at least one embodiment of the present disclosure. System 200 comprises user device 210, server 220, database 230, provider device 240 and computer network 260. For purposes of clarity, only one user device 210 and one provider device 240 is shown in FIG. 2. However, it is within the scope of the present disclosure that the system 200 may any number of user devices 210 and provider devices 240 at one time.

The user device 210 and provider device 240 may each be configured to transmit information to and generally interact with a web services infrastructure housed on server 220 over computer network 260. The user device 210 and provider device 240 may include a web browser, mobile application, or other network connected software such that communication with the web services infrastructure on server 220 is possible over the computer network 260. User device 210 and provider device 240 each includes one or more computers, smartphones, tablets, wearable technology, computing devices, or systems of a type well known in the art, such as a mainframe computer, workstation, personal computer, laptop computer, hand-held computer, cellular telephone, or personal digital assistant. User device 210 and provider device 240 each comprises such software, hardware, and componentry as would occur to one of skill in the art, such as, for example, one or more microprocessors, memory systems, input/output devices, device controllers, and the like. User device 210 and provider device 240 each also comprises one or more data entry means (not shown in FIG. 2) operable by users of user device 210 and provider device 240 for data entry, such as, for example, a pointing device (such as a mouse), keyboard, touchscreen, microphone, voice recognition, and/or other data entry means known in the art. User device 210 and provider device 240 also comprises a display means (not shown in FIG. 2) which may comprise various types of known displays such as liquid crystal diode displays, light emitting diode display, and the like upon which information may be display in a manner perceptible to the user.

As described above, the server 220 may be configured to health information, proscribed medication, doctor's notes, personal information and other information from the user device 210 and provider device 240 to establish a coordinated care plan. In at least one embodiment, the server 220 accesses the database 230 to store health information, proscribed medication and other information transmitted from the user device 210 and provider device 240 or generated through each device interacting with the server 220 in the methods and disclosed herein. The server 220 is configured to carry out one or more of the steps of methods described herein.

The user device 210 and provider device 240 each are further configured to provide input to the server 220 to carry out one or more of the steps of the methods described herein. Server 220 comprises one or more server computers, computing devices, or systems of a type known in the art. Server 220 further comprises such software, hardware, and componentry as would occur to one of skill in the art, such as, for example, microprocessors, memory systems, input/output devices, device controllers, display systems, and the like. Server 220 may comprise one of many well-known servers and/or platforms, such as, for example, IBM's AS/400 Server, RedHat Linux, IBM's AIX UNIX Server, MICROSOFT's WINDOWS NT Server, AWS Cloud services, Rackspace cloud services, any infrastructure as a service provider, or any platform as a service provider.

In FIG. 2, server 220 is shown and referred to herein as a single server. However, server 220 may comprise a plurality of servers, virtual infrastructure, or other computing devices or systems interconnected by hardware and software systems know in the art which collectively are operable to perform the functions allocated to server 220 in accordance with the present disclosure.

The database 230 is configured to store patient information, health information, proscribed medication, and the like. The database 230 may be an electronic health record or integrate with an electronic health record management system. Database 230 is “associated with” server 220. According to the present disclosure, database 230 can be “associated with” server 220 where, as shown in the embodiment in FIG. 2, database 230 resides on server 220. Database 230 can also be “associated with” server 220 where database 230 resides on a server or computing device remote from server 220, provided that the remote server or computing device is capable of bi-directional data transfer with server 220, such as, for example, in Amazon AWS, Rackspace, or other virtual infrastructure, or any business network. In at least one embodiment, the remote server or computing device upon which database 230 resides is electronically connected to server 220 such that the remote server or computing device is capable of continuous bi-directional data transfer with server 220.

For purposes of clarity, database 230 is shown in FIG. 2, and referred to herein as a single database. It will be appreciated by those of ordinary skill in the art that database 230 may comprise a plurality of databases connected by software systems of a type well known in the art, which collectively are operable to perform the functions delegated to database 230 according to the present disclosure. Database 230 may comprise a relational database architecture or other database architecture of a type known in the database art. Database 230 may comprise one of many well-known database management systems, such as, for example, MICROSOFT's SQL Server, MICROSOFT's ACCESS, or IBM's DB2 database management systems, or the database management systems available from ORACLE or SYBASE. Database 230 retrievably stores information that are communicated to database 230 from user device 210, provider device 240 or server 220.

User device 210, provider device 240 and server 220 communicate via computer network 260. If database 230 is in disparate infrastructure from server 220, database 230 may communicate with server 230 via computer network 260. Computer network 260 may comprise the Internet, but this is not required.

It should be appreciated that the systems and methods disclosed herein are further exemplified in the mock up scenario attached hereto as Attachment A.

While the description above refers to particular embodiments of the present invention, it will be understood that many modifications may be made without departing from the spirit thereof. The accompanying concepts are intended to cover such modifications as would fall within the true scope and spirit of the present invention. The presently disclosed embodiments are therefore to be considered in all respects illustrative and not restrictive, the scope of the invention being indicated by the appended concepts, rather than the foregoing description, and all changes which come within the meaning and range of equivalency of the concepts are therefore intended to be embraced therein.

What is claimed is:

1. A computerized method for coordinating health care plans, the method comprising:
receiving a first health care plan for a patient from a first provider, the first health care plan comprising a plurality of first health events;
receiving a second health care plan for the patient from a second provider, the second health care plan comprising a plurality of second health events;
combining the first health events with the second health events into a coordinated health care plan, the health care plan comprising a plurality of third health events;
receiving at least one threshold for at least one of the third health events from the first provider; and
alerting the first provider upon receiving an indication that at least one of the third health events is outside the threshold.

2. The method of claim 1, wherein each of the third health events is selected from a food event, measurement event, bowel movement event, and medication event.

3. The method of claim 1, wherein the first health care plan and second health care plan are each related to distinct chronic illnesses.

4. The method of claim 1, where the alerting step is performed on a user electronic device.

5. The method of claim 1, further comprising:
receiving a plurality of health information from the patient from a patient electronic device; and
associating each health information in the plurality of health information to at least one health event.

6. The method of claim 1, further comprising:
receiving an acceptance of the first provider from the patient, the acceptance indicating that the patient authorizes the first provider to implement the first health plan; and
implementing the first health plan for the patient.

7. The method of claim 6, wherein the acceptance is received after the implementing step.

8. A system for coordinating health care plans, the system comprising:
a user device;
a database;
a server configured to receive a first health care plan for a patient from a first provider, the first health care plan comprising a plurality of first health events, receive a second health care plan for the patient from a second provider, the second health care plan comprising a plurality of second health events, insert the first health care plan and the second health care plan into the database, combine the first health events with the second health events into a coordinated health care plan in the database, the health care plan comprising a plurality of third health events, receive at least one threshold for at least one of the third health events from the first provider; and transmit an alert to the first provider at the user device upon receiving an indication that at least one of the third health events is outside the threshold.

9. The system of claim 8, wherein each of the third health events is selected from a food event, measurement event, bowel movement event, and medication event.

10. The system of claim 8, wherein the first health care plan and second health care plan are each related to distinct chronic illnesses.

11. The system of claim 8, wherein the server is further configured to receive a plurality of health information from the patient from a patient electronic device, and associate each health information in the plurality of health information to at least one health event in the database.

12. The system of claim 8, wherein the server is further configured to receive an acceptance of the first provider from the patient, the acceptance indicating that the patient authorizes the first provider to implement the first health plan, implement the first health plan for the patient.
